(19) United States
(12) Patent Application Publication
(10) Pub. No.: US 2014/0032382 A1
(43) Pub. Date: Jan. 30, 2014

(54) COMPENSATION RECOMMENDATIONS

(71) Applicant: Platypus Business Systems, Inc., Denver, CO (US)

(72) Inventors: Paul Stephen Hamann, Denver, CO (US); Richard L. Perry, Oakland Park, FL (US)

(73) Assignee: Platypus Business Systems, Inc., Denver, CO (US)

(21) Appl. No.: 13/954,040

(22) Filed: Jul. 30, 2013

Related U.S. Application Data
(60) Provisional application No. 61/677,141, filed on Jul. 30, 2012.

(51) Int. Cl. G06Q 10/10

(52) U.S. Cl. CPC G06Q 10/1091
USPC 705/32

(57) ABSTRACT

The compensation recommendation system disclosed herein allows a user to determine compensations for a plurality of tasks, determine tasks performed by a user on one or more of the plurality of tasks, determine time spent by a user on the one or more of the plurality of tasks, and determine the reasonable compensation of the user using the compensations for the one or more of the plurality of tasks and the time spent by the user on the one or more of the plurality of tasks. The compensation recommendation system may be used by a business owner to determine reasonable compensation based on time spent on a number of tasks.

### CROSS-REFERENCE TO RELATED APPLICATIONS

The present application claims benefit of priority to U.S. Provisional Patent Application No. 61/677,141 entitled “Compensation Recommendation” and filed on 30 Jul. 2012, which is specifically incorporated by reference herein for all that it discloses or teaches.

### FIELD

Implementations disclosed herein relate, in general, to the information management technology and specifically to technology for generating recommendations.

### SUMMARY

The compensation recommendation system disclosed herein allows a user to determine compensations for a plurality of tasks, determine tasks performed by a user on one or more of the plurality of tasks, determine time spent by a user on the one or more of the plurality of tasks, and determine the reasonable compensation of the user using the compensations for the one or more of the plurality of tasks and the time spent by the user on the one or more of the plurality of tasks. The compensation recommendation system may be used by a business owner to determine reasonable compensation based on time spent on a number of tasks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 is an example block diagram of a compensation recommendation system.

FIG. 2 is an alternative example block diagram of a compensation recommendation system.

FIG. 3 is an example flow diagram of the home page providing compensation recommendations.

FIG. 4 is an example flow diagram of user interface page or user dashboard.

FIG. 5 is an example flow diagram of the client interview.

FIG. 6 is an example flow diagram of the standard tasks in the client interview.

FIG. 7 is an example flow diagram of the customizable tasks by keyword search or alphabetical listing.

FIG. 8 is an example flow diagram of the category time allocation of standard and customizable categories.

FIG. 9 is an example flow diagram of the task time allocation and proficiency rating by task within each category.

FIG. 10 illustrates an alternative example home page providing compensation recommendations.

FIG. 11 illustrates an example industry specific landing page.

FIG. 12 illustrates an example user interface or user dashboard ‘my clients’ tab.

FIG. 13 illustrates an example user interface or user dashboard ‘my reports’ tab.

FIG. 14 illustrates an example user interface or user dashboard ‘order report’ tab.

FIG. 15 illustrates an example user interface or user dashboard ‘my profile’ tab.

FIG. 16 illustrates an example user interface or user dashboard ‘my password’ tab.

FIG. 17 illustrates an example user interface or user dashboard ‘system users’ tab.

FIG. 18 illustrates an example user interface or user dashboard ‘credit pool’ tab.

FIG. 19 illustrates an example user interface or user dashboard ‘pool history’ tab.

FIG. 20 illustrates an example user interface or user dashboard ‘help’ tab.

FIG. 21 illustrates an example client interface or client interview ‘my state’ tab.

FIG. 22 illustrates an example client interface or client interview ‘my county’ tab.

FIG. 23 illustrates an example client interface or client interview ‘my company’ tab.

FIG. 24 illustrates an example client interface or client interview ‘standard tasks’ tab.

FIG. 25 illustrates an example client interface or client interview ‘my tasks’ tab.

FIG. 26 illustrates an example client interface or client interview ‘category time allocation’ tab.

FIG. 27 illustrates an example client interface or client interview ‘task time allocation’ tab.

FIG. 28 illustrates an example reasonable compensation report.

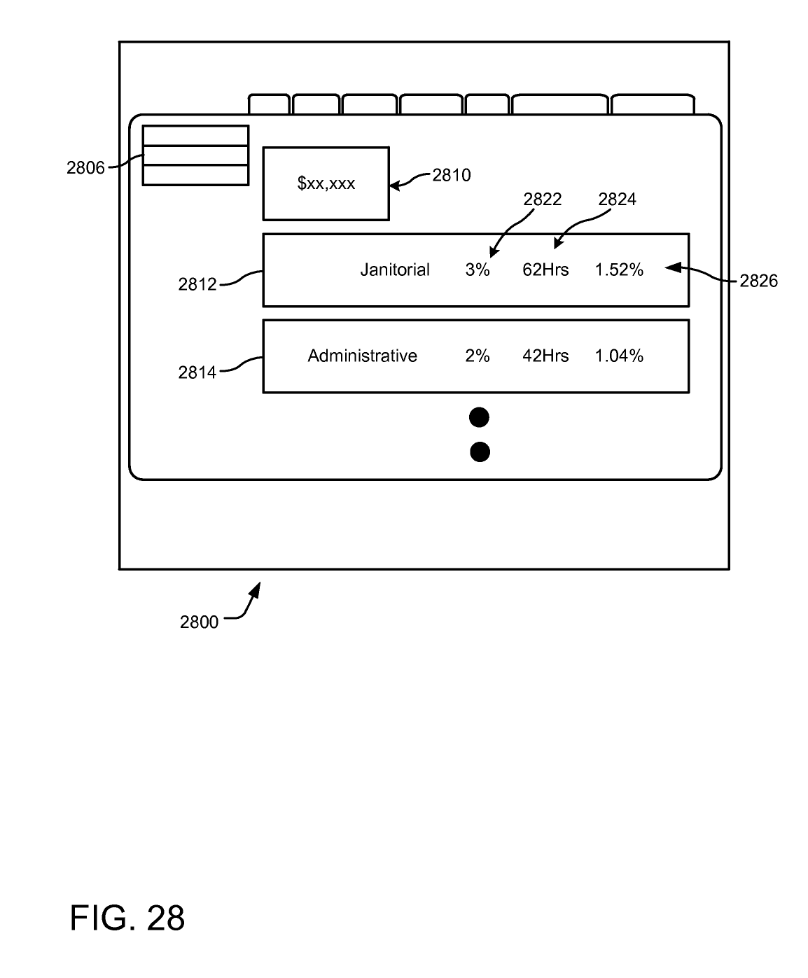

FIG. 29 illustrates an example network environment for implementing the information cataloging system disclosed herein.

FIG. 30 illustrates an example computing system that can be used to implement the recommendation system disclosed herein.

FIG. 31 illustrates an example mobile computing device that can be used to implement one or more components of the recommendation system disclosed herein.

### DETAILED DESCRIPTION

Generally, compensation of a person is based on the type of work that they do, their skill set, the compensation of other professionals in given geographic area that perform comparable tasks, etc. Accountants and other professionals generally advise their clients to determine their compensation based on one or more of the factors discussed above. However, small business owners perform a number of tasks as part of their day-to-day duties. Furthermore, for most small businesses it is not possible to find comparable businesses where the owners perform tasks similar to the tasks performed by a given small business owner. For example, an attorney working as a solo practitioner also performs bookkeeping, marketing, etc. Furthermore, the amount of time spent by one solo attorney on such ancillary tasks is not the same as that spent by another solo attorney. Therefore, it is difficult to find another attorney that also spends the same amount of time on such ancillary tasks.

The internal revenue services (IRS) has pretty strict guidelines as to the amount of compensation that a business owner has to pay to himself/herself. For example, for every $10,000 that a business owner underpays himself below what the IRS considers to be the reasonable compensation, the tax penalty of the business owner increases by $1,530.

Furthermore, the increased liability may also be assessed interests and penalties. Furthermore, once the IRS finds out about a mistake in calculation of such reasonable compensation, the IRS audits additional two more years of returns for such miscalculation of reasonable compensation.

A compensation recommendation system disclosed herein allows small business owners to answer this question of what is the reasonable compensation for the business owner's duties and responsibilities. Specifically, the compensation recommendation system allows a business owner to answer a number of questions and the system determines a reasonable compensation based on the business owner's answers. An implementation of the recommendation system conducts a thorough online interview to determine the reasonable compensation. Specifically, the recommendation system helps the business owner to classify and apportion his or her work into eight common functional areas and areas specific to their business. However, in an alternate implementation, the recommendation system may also classify the work into more or less number of categories. Furthermore, while an implementation of the recommendation system asks the business owner to classify his or her work on an annual basis to generate a recommendation for reasonable annual compensation, in an alternative implementation, the recommendation may also be generated based on survey of monthly work, etc.

The recommendation system disclosed herein can be used directly by a business owner or by a representative of the business owner, such as the accountant of the business owner, financial planner of the business owner, etc., to determine the reasonable compensation for the business owner. In one example, implementation, the online survey calculates the reasonable compensation of the business owner using the following five criteria: (1) training and experience, (2) duties and responsibilities, (3) time and effort devoted to business, (4) comparable pay for similar services by comparable businesses, and (5) a calculation formula with various weightings. In one implementation, the business owner is provided the formula and/or allowed to change the weightings used by the formula. Also, the business owner, or the representative of the business owner, is also provided the opportunity to add one or more additional criteria for determining reasonable compensation. For example, below is a list of other factors that are considered by the compensation recommendation system when generating a compensation recommendation: dividend history, payments to non-shareholder employees, timing and manner of paying bonuses to key employees, compensation agreements, etc. Subsequently, the system receives time spent by the business owner on one or more of the selected tasks. Such time may be approximate or estimated time or the actual time based on real time input by the business owner.

In one implementation, the formula used by the compensation recommendation system is also dependent upon the type of the business entity. For example, different questions may be presented to a business owner who is owner of a small business compared to an owner of a large business, etc. Yet alternatively, the questions presented to the business owners are also dependent upon a number of other factors, such as classification of the business, the state of incorporation of the business, the state where the business is active, etc.

A sample report generated by the recommendation system based on the business owner's input during the survey is attached herewith as Appendix A. In one implementation, if a business owner completes an online survey provided by the compensation recommendation system and identifies a particular firm as the CPA for the business, the CPA is notified by the recommendation system when the compensation report is generated by the recommendation system.

In yet alternative implementation, the compensation recommendation system disclosed herein further comprises generating a database of reasonable compensation for each of a number of various types of duties and responsibilities. For example such as database may provide the reasonable compensation for janitorial services in a given city by a person of given level of experience. For example, the database may provide that in Denver, Colo., a janitor with five years of experience in janitorial services is paid $10.75 per hour on average. Such databases of reasonable compensations may have the reasonable compensations categorized by city, state, experience, time of year, etc. For example, for a retail storeowner, the reasonable compensation for floor sales may be higher in December due to holidays whereas such compensation may be lower in summer due to excess availability of part-time seasonal labor in form of college students. Yet alternatively, the database also includes information about the overtime practice in a given location. Thus, if it is common or required that the employees are paid overtime after certain number of hours per week, the database will have such information stored therein. Subsequently, the compensation recommendation system uses one or more of such information stored in the compensation database to generate a recommendation for reasonable compensation. Yet alternatively, other factors such as the number of employees for the small business, the revenue of the business, the industry, etc., are also considered in generating the recommended value of reasonable compensation.

Other criteria used by the IRS, such as discriminate index function (DIF), may also be considered. For example, in one implementation, the results of IRS audits for a particular business or other businesses that are similar to that particular business are also taken into consideration when determining the value of reasonable compensation. The table below is a summary of the various criteria used in generating the value of reasonable compensation:

Geographic Location
Industry classification
Duty type
Revenue of the business
Gender of the business owner
Age of the business owner
Skill level of the business owner
Experience of the business owner for the duty
Time of year
Type of the business entity
Number of employees at the business
Opportunity cost to the business owner
Health care and other overhead for employees
Vacation and other benefits
Business owner's expected compensation
Unemployment levels in the industry/geography
Results of IRS audits
Total hours worked by the business owner
Results from other compensation reports
Education

Other criteria may also be used. Yet alternatively, the database of reasonable compensation may be designed so that it is constantly updated based on the output recommendations generated by various users. For example, if a business owner for a coffee store in Denver using the compensation recommendation system determines that based on his duties, experience and other factors, the reasonable recommendation for him is $65,000, this result itself is added as an observation point in the compensation database. Yet alternatively, the recommendation system also asks the users and/or their representative for input about recommended compensations. For example, the recommendation system may ask an owner of a wine sales business in Denver about his or her expected hourly compensation for moving wine boxes into a restaurant. If such owner recommends that he expects to be paid $8.50 for such task, the compensation recommendation system adds such expectation as a data point into the compensation database for future use.

In an alternative implementation, the recommendation system allows a business adviser, such as an accountant, a financial planner, etc., to become an affiliate of the recommendation system such that the adviser is paid a reward for reviewing a compensation report and advising a small business owner based on the compensation report.

In one implementation, the compensation recommendation system updates the recommendation constantly based on updates to the database. Alternatively, the compensation maybe determined at a given point and held constant for the rest of the year and updated only on annual basis. Once the recommendation for reasonable compensation is provided to the user, the recommendation system compares the reasonable compensation to the expected profit for the small business. Based on such comparison, the recommendation system recommends the small business owner whether the owner is profiting beyond reasonable salary for his or her tasks and duties or not.

An alternative implementation of the recommendation system also stores, combines and analyzes the inputs from a large number of users. For example, the recommendation system may combine the number of hours spent by business owners in coffee shops over time to determine the average time spent by a coffee shop owner in training his or her employees. Based on such averages, the recommendation compensation system may also advise a particular business owner whether such owner is spending too much time or too little time in employee training. Yet alternatively, the compensation recommendation system may also analyze the relationships between time spent on various tasks and the profit levels, revenue or other values to further advise small business client about the what kind of duties and responsibilities the owner should focus on. Thus, if the recommendation system finds a high correlation between time spent on marketing and total revenues, the recommendation system may notify a business owner with less time spent on marketing to increase such time. Thus, the data and the analysis results are used for teaching, consulting small businesses, etc.

Yet alternatively, the data collected by the compensation recommendation system may also be used in evaluating small businesses. For example, one of the information input needed in evaluating small businesses is to determine the portion of earnings coming from work performed by the business owner based on reasonable compensation due the business owner given the time, experience, skill level, training, etc.

Now referring to example implementations of the recommendation system disclosed herein, an implementation disclosed herein walks a small business owner though a compensation survey/questionnaire consisting of 38 common tasks in eight different categories to accurately apportion what a small business owner does over the course of a period, for example, a year. Note that in an alternative implementation more or less than 38 tasks and more or less than eight categories may be used. In one implementation, the categories include job titles that are derived from 6,597 job titles and 840 occupation classified by the bureau of labor statistics (BLS) into the following eight common business categories

1. Janitorial—Maintenance—Landscape

2. Administrative—Secretarial—Clerk

3. Advertising—Sales—Marketing

4. Accounting—Bookkeeping—Finance

5. Human Resources—Compensation—Training

6. Information Technology—Computer

7. Purchasing—Inventory—Shipping—Receiving

8. Management—Supervision

However, in alternative implementation, other titles and categories may be used. Such salary and wages data is updated on a periodic basis. However, alternatively, aged data is saved to support calculation of past reasonable compensation reports. Yet alternatively, the recommendation system also provides an option to generate a report based on past wage and salary data. Furthermore, quite often, if a data point is not available from BLS, statistical modeling may be used to extrapolate existing wage data to infer the missing data. For example, if the wage data for a gravedigger is missing for the city of Denver, the wage data for a gravedigger in Boulder, adjusted for the cost of living difference between the city of Boulder and the city of Denver, may be used to generate the missing wage data.

Furthermore, within each of the eight business categories there are four to eight occupations that are commonly performed within each category—38 in total spread among the eight categories. A ninth category is generated that the business owner can use to select what they do specific to their business. They can select as many ‘wild card’ job tasks as they need to complete their profile. From the pre-listed job tasks and the wild card job task a business owner selects any and all tasks they perform throughout the year. Subsequently, the business owner apportions their time among the nine categories by giving the percentage of time spent in each category or the actual time spent in each category. For any category where there are more than one job tasks selected by the business owner, the recommendation system asks the business owner to apportion the time within that category. The recommendation system also asks for the location information about where the job is to be performed from the business owner.

After receiving the input from the business owner, the recommendation system uses the wage data and various inputs from the business owner to determine the recommended compensation for the business owner. The recommended compensation information can be used to determine compensation based on IRS guidelines, for determining executive compensation in C corporations, for determining executive pay in non-profit organization, to determine reasonable compensation for clergy and staff, to determine compensation for shareholder of S corporation, etc. Furthermore, the reports generated by the recommendation system may also be used in business valuation, in divorce proceedings, retirement and estate planning, in execution of estates, for barter or trade transactions, etc.

In one implementation, the recommendation system is web based in that a user can access various functionalities of the recommendation system by logging on to a website hosted in a webserver. Alternatively, a user may be able to access such system from a personal data assistant, a smartphone, a tablet computing device, etc. Yet alternatively, the recommendation system may also have a client application running on the end user's computer that interacts with a host application residing on a server. The following describes an example implementation of such a recommendation system using web server that interacts with a browser installed on an end user's computer.

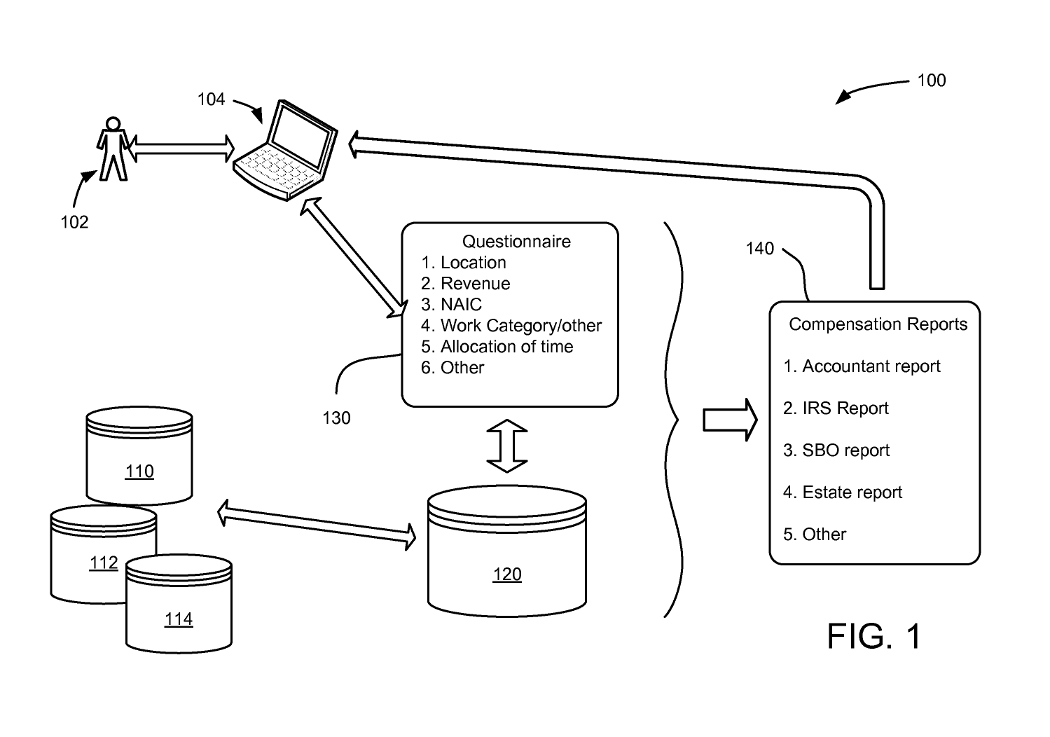

FIG. 1 illustrates a compensation recommendation system 100 disclosed herein. Specifically, the compensation recommendation system 100 generates recommendations for reasonable compensations for a user 102. The user 102 may access the compensation recommendation system 100 using a computing device 104, such as a laptop, a desktop, a tablet device, etc. The compensation recommendation system 100 may reside on a server, one a collection of servers, etc. In one implementation, the compensation recommendation system 100 presents a graphical user interface (GUI) 130 to the user 102. For example, such GUI 130 may be presented via a web page, via an application running on a tablet or mobile device, etc.

The GUI 130 may present a questionnaire to the user with a number of questions related to the user's business, classification of business as per national association of industrial classification (NAIC) codes, tasks, location, etc. In one implementation, the GUI 130 is an interactive GUI where in response to one or more questions, a more detailed or specific questions are presented to the user. For example, the questions related to the location may be presented in a sequence, where first a question about the state where the business is located is presented and in response to the selection of the state, a question about the county of the business is presented. Similarly, the questions about the allocation of time may first present a listing of various standard tasks and option for selecting one or more personalized tasks. Subsequently, for each of the selected tasks, questions about the user's experience, the amount of time spent on that task, etc., are presented. In one implementation, the compensation recommendation system 100 changes the listing of the work categories based on the selection of the NAIC code by the user.

The GUI 130 may be generated using a server, etc., that is communicatively connected to a recommendation database 120. For example, the recommendation database 120 collects and stored information about reasonable compensation for various tasks based on location, experience, etc. In one implementation, the recommendation database 120 may also be connected to a number of databases 110, 112, 114 that store compensation information. For example, the database 110 may be a bureau of labor statistics (BLS) database that provides data about compensation for various jobs based on the location of such jobs. Alternatively, the database 112 may be a web server database for an employment information provider, such as salary.com, etc. The compensation database 120 collects the information from the databases 110, 112, 114 to generate various tables, relational database, etc., that can be accessed by the GUI 130 and by other modules of the compensation recommendation system 100.

The compensation recommendation system 100 uses the responses provided by the user 102 to the GUI 130 and retrieves information from the recommendation database 120 to generate a reasonable recommendation for the user. For example, the compensation recommendation system 100 may have one or more modules that weighs the reasonable compensation for a task based on the amount of time spent by the user on that task, and adds the weighted totals for each of the tasks on which the user spends time. In one implementation, the compensation recommendation system 100 keeps track of the user's time on a real-time basis and dynamically calculates the reasonable compensation for the user based on the actual time spent by the user on various tasks. For example, a module of the compensation recommendation system 100 may be communicatively connected to a time-keeping module used by the user 104 where the user keeps track of his or her time on various tasks.

The compensation recommendation system 100 may present a reasonable compensation report 140 to the user 102 where the report 140 provides detailed analysis of time spent by the user on various tasks, the reasonable compensation for each of these various tasks, percentage of total compensation allocated to a given task, attribution of each of the various tasks to the total compensation, etc. In one implementation, the compensation reports 140 may be modified based on the recipient of the compensation report. Thus, some of the information that was presented to the user 102 may be redacted when such a report is presented to a third party such as an accountant, the IRS, an estate attorney, etc.

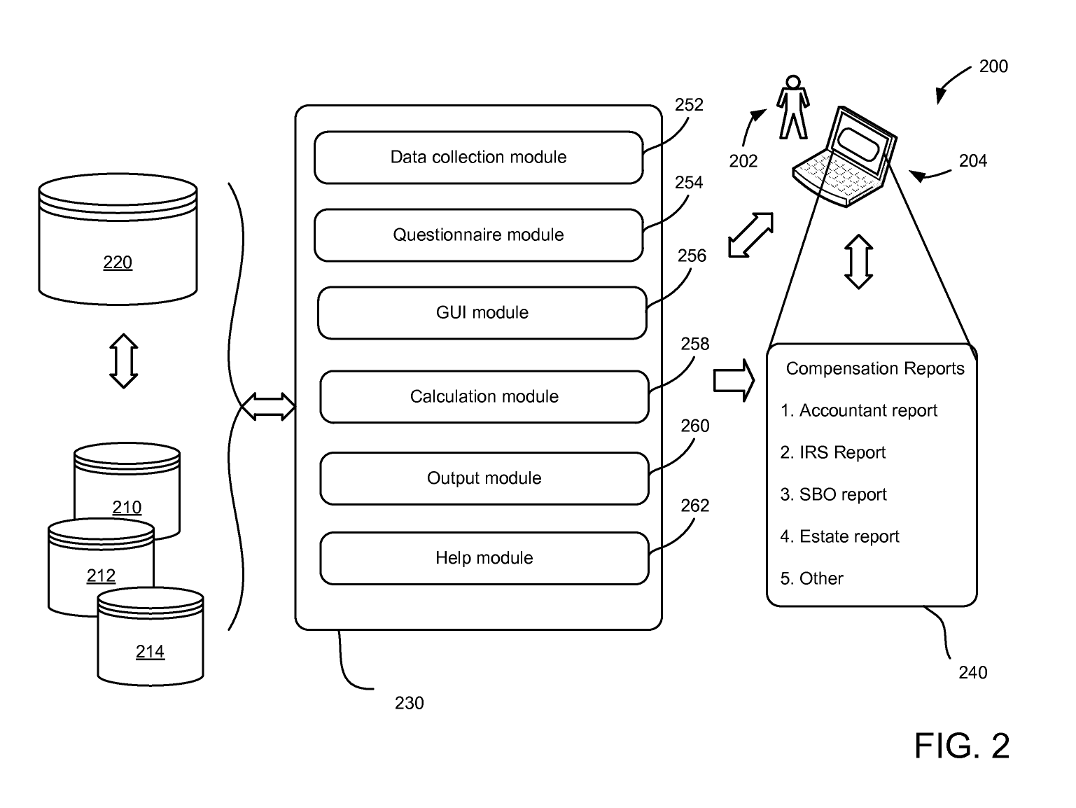

FIG. 2 illustrates alternative implementation of a compensation recommendation system 200 disclosed herein. The compensation recommendation system 200 includes a compensation recommendation engine 230 that allows a user 202 to generate and review one or more compensation recommendations. The compensation recommendation engine 230 may be implemented using a computing device such as a server or a plurality of servers. The compensation recommendation engine 230 is communicatively connected to various databases 210, 212, 214 and 220. In one implementation, the compensation recommendation engine 230 collects data from the databases 210, 212, 214 and populates the database 220 with various information related to reasonable compensation. For example, the database 210 may be a BLS database and the compensation recommendation engine 230 sends one or more queries to the BLS database 210 to extract information about reasonable compensation for various tasks. Thus, the compensation recommendation engine 230 may request compensations for administrative assistants for a given county from the BLS database 210 and store it in the compensation database 220.

The user 202 accesses the compensation recommendation engine 230 via a computing device 204, such as a laptop, desktop, etc. In one implementation, the compensation recommendation engine 230 include a data collection module 252 that collects data from various databases 210, 212, 214, 220 for generating compensation recommendations. A questionnaire module 254 presents one or more questionnaires for the user 202, where such questionnaires may be presented to the user buy a GUI module 256. For example, the questionnaires presented to the user 104 may request the user to select various tasks performed by the user 202 and the estimated amount of time spent by the user 202 on these tasks. A calculation module 258 weights the reasonable compensation for the various tasks by the percentage of time spent by the user on that particular task. The weighted total may be used as the reasonable compensation for the use's 202 work.

For example, for the user 202 based on Denver, Colo., the reasonable compensation for various tasks and the time spent by the user on the various tasks is provided in the first two columns in Table I below.

| | Reason- | | | |
|---|---|---|---|---|
| | able | Time | | Attribution to |
| | Comp | (hrs per | | Total (weekly) |
| Task | (per hr) | week) | Weight | Compensation |
| Janitorial-Maintenance- | $6.25 | 2 | 3.33% | $12.50 |
| Landscape | | | | |
| Administrative-Secretarial- | $8.00 | 6 | 10.00% | $48.00 |
| Clerical | | | | |
| Advertising-Sales- | $12.50 | 6 | 10.00% | $75.00 |
| Marketing | | | | |
| Accounting-Bookkeeping- | $15.00 | 8 | 13.33% | $120.00 |
| Finance | | | | |
| Human Resources- | $15.00 | 4 | 6.67% | $60.00 |
| Compensation-Training | | | | |
| Information Technology- | $32.00 | 4 | 6.67% | $128.00 |
| Computer | | | | |
| Purchasing-Inventory- | $12.00 | 2 | 3.33% | $24.00 |
| Shipping-Receiving | | | | |
| Management-Supervision | $20.00 | 8 | 13.33% | $160.00 |
| Other (user specific) | $45.00 | 20 | 33.33% | $900.00 |
| Total | | 60 | | |
| Total Weekly | | | | $1,527.50 |
| Compensation | | | | |

In one implementation, the compensation for the user specific task may be determined based on an input from the user or from predictive analysis of the task defined by the user. For example, if the user specifies a user specific task as patent litigation, the compensation recommendation engine 230 may use 202 the rates for attorneys working on patent litigation in Denver, Colo. to determine the reasonable compensation for the user 202. An output module 260 generates compensation reports 240 based on the computed reasonable compensation. For example, the output module 260 may generate various compensation reports for various recipients, such as the user 202, an accountant of the user 202, the IRS, etc. The compensation recommendation engine 230 may also include a help module that assists the user 202 throughout the process of generating the compensation reports 240.

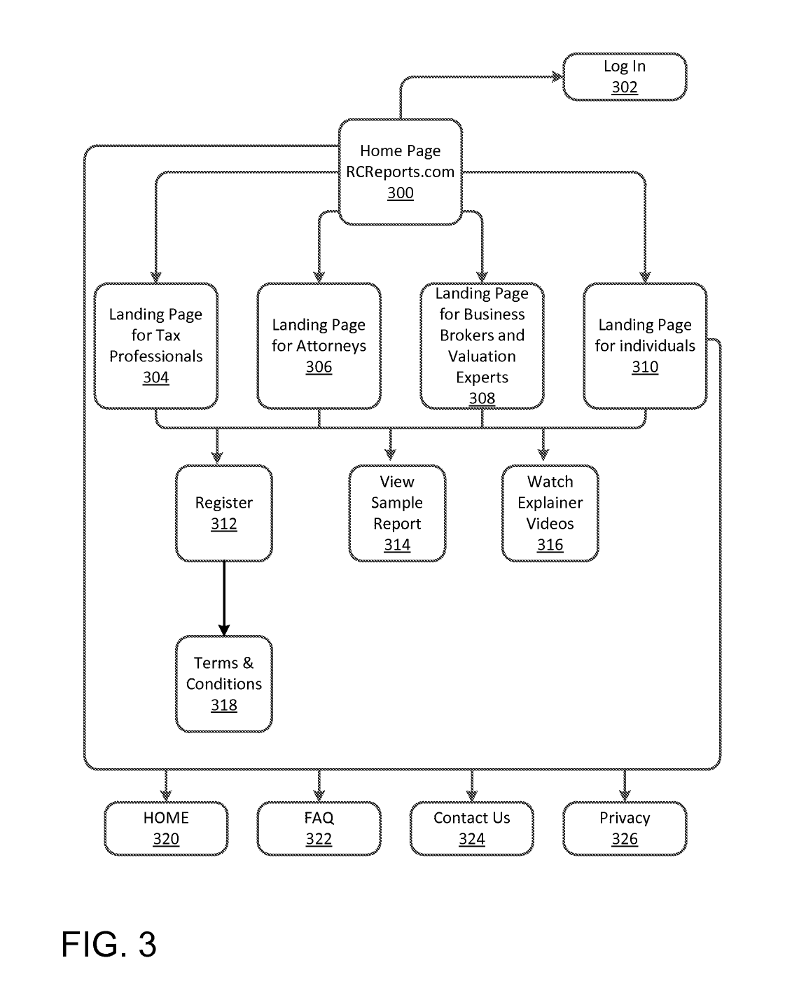

FIG. 3 is an example flow diagram of the home page 300. The home page 300 displays links to specific landing pages by industry profession: tax professionals 304, attorneys 306, business brokers and valuation experts 308, individuals 310. These pages contain more detailed sales and product information targeted at each profession. From landing pages by industry profession the user can link to a registration 312 button, view sample report 314 link, view promotional videos and videos explaining the web site 316 link. From the registration 312 button users can view and agree or disagree with terms and conditions 318. From the home page 300 the user can link to frequently asked questions 322, a contact us page where the user can send us an email or request us to call them at a specified time 324, and a privacy disclosure 326. The user can also log into their user interface or ‘dashboard’ if they have previously registered from the log in field 302. The user can view the terms and conditions using a button 318.

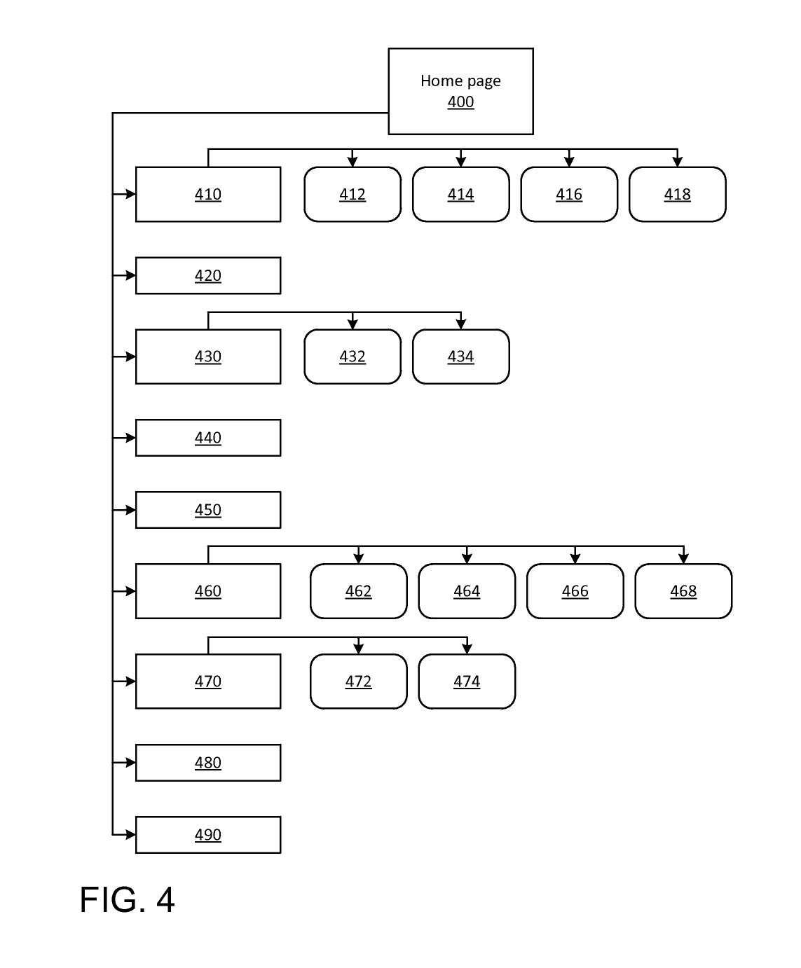

FIG. 4 is an example flow diagram of user interface page or user dashboard 400. The my clients tab 410 allows the user to add new clients 418, view reports the client has pending, in progress, awaiting review and locked reports 416, view and edit a client profile 414, and manage all clients from clients home 412. The “my reports” tab 420 gives the user one screen to view all their clients reports and the report status. The order reports tab 430 allows users to purchase reports for clients 430 and after purchasing a report for a client gives the user a choice as to how to begin the reasonable compensation interview by beginning the interview immediately 432, and/or sending a link to begin the interview to their client 434. The “my profile” tab 440 allows the user to view and edit their profile. The “my password” tab 450 allows the user to change their password. The systems user tab 460 allows the user to add additional users 468, manage the permissions of other users 466, view and edit the profile of other users 464, and manage all users from system users home 462. The credit pool tab 470 and purchase credits tab 472 allow the user to purchase credits in a variety of packages to fit their business and firm size, and also allows the user to view a pricing matrix 474 outlining and detailing credit pricing and report cost in a variety of different configurations based on credit purchase package and report type. The pool history tab 480 keeps track of all credit purchases and all reports ordered for the user. The help tab 490, gives the user a quick place to go for frequently asked questions, training videos, technical information and the ability to send us an email or request a phone call.

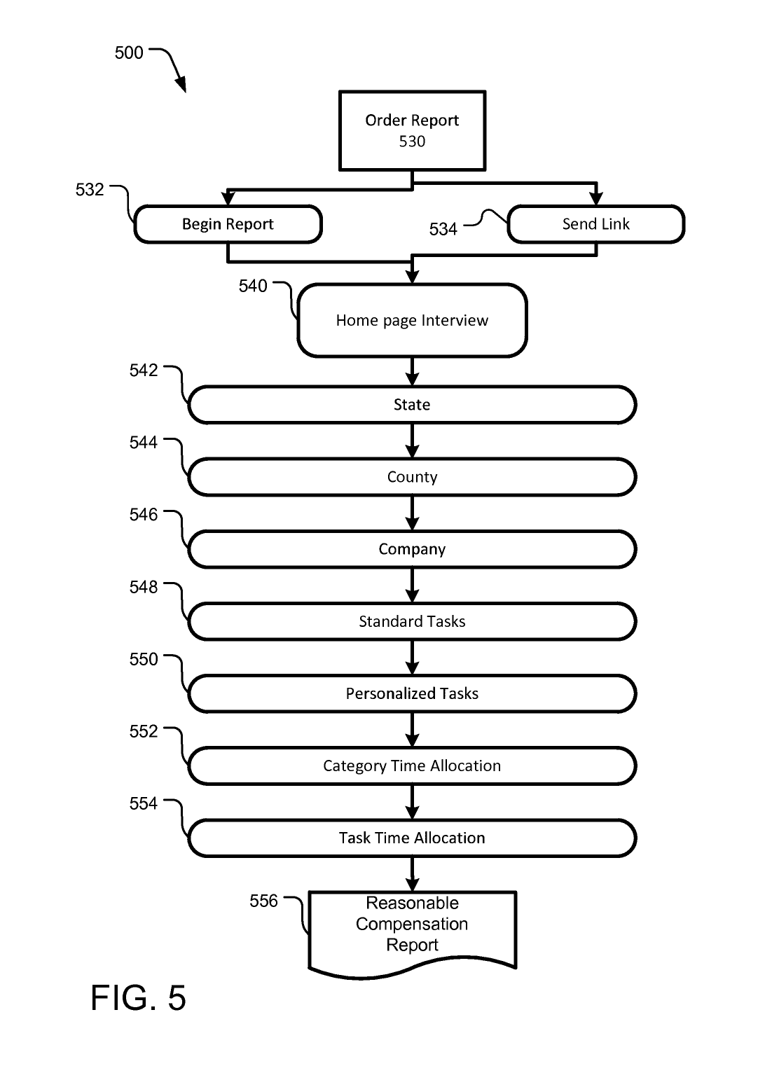

FIG. 5 is an example flow diagram of the client interview 500. The user can initiate the interview to order a report by selecting tab 530. Subsequently, at 532 the user begins the report or at 534 sends a link to another person. The interview starts at 540. The “my state” tab 542 is the first step in the interview where the client selects the state in which they work. The “my county” tab 544 is the second step in the interview where the client selects what county in which they perform work. The “my company” tab 546 is the third step in the interview where the client provides additional information about their business size, structure and their work habits. The “standard tasks” tab 548 is the fourth step in the interview which leads the client through eight standard categories, each containing tasks that are commonly a part of managing or running a small business. The “personalized tasks” tab 550 is the fifth step in the interview which leads the client through identifying and selecting specialized tasks specific to their business which fall outside the common tasks they have previously selected from in step four. The “category time allocation” tab 552 is the sixth step in the interview and requires the client to allocate their time among all the categories in which they perform one or more tasks. The “task time” allocation tab 554 is the seventh step in the interview and requires the client to allocate their time in categories in which they selected more than one task and rate their proficiency in all tasks selected. At the completion of step seven the client can review and edit their responses to the interview and view their reasonable compensation report 556.

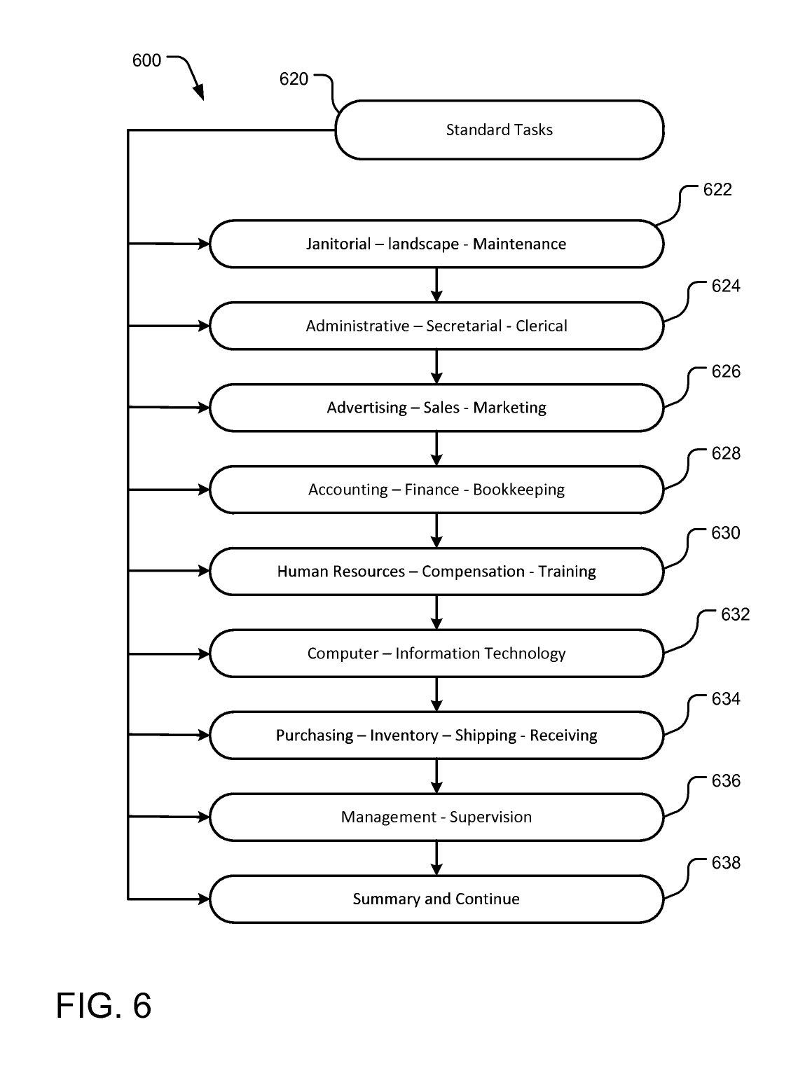

FIG. 6 is an example flow diagram 600 of operations initiated in response to a standard tasks tab 620 from step four of the client interview. The client can proceed through each tab in order or jump from tab to tab in any order. The Janitorial—Landscape—Maintenance tab 622 allows the client to select from three tasks commonly performed by small business owners specific to this category. The Administrative—Secretarial—Clerk tab 624 allows the client to select from six tasks commonly performed by small business owners specific to this category. The Advertising—Sales—Marketing tab 626 allows the client to select from six tasks commonly performed by small business owners specific to this category. The Accounting—Finance—Bookkeeping tab 628 allows the client to select from six tasks commonly performed by small business owners specific to this category. The Human Resources—Compensation—Training tab 630 allows the client to select from three tasks commonly performed by small business owners specific to this category. The Computer—Information Technology tab 632 allows the client to select from three tasks commonly performed by small business owners specific to this category. The Purchasing—Inventory—Shipping—Receiving tab 634 allows the client to select from four tasks commonly performed by small business owners specific to this category. The Management—Supervision tab 636 allows the client to select from seven tasks commonly performed by small business owners specific to this category. After the client selects tasks they commonly perform in their business they can review all their answers and then continue the interview from the Summary and Continue 638 Tab.

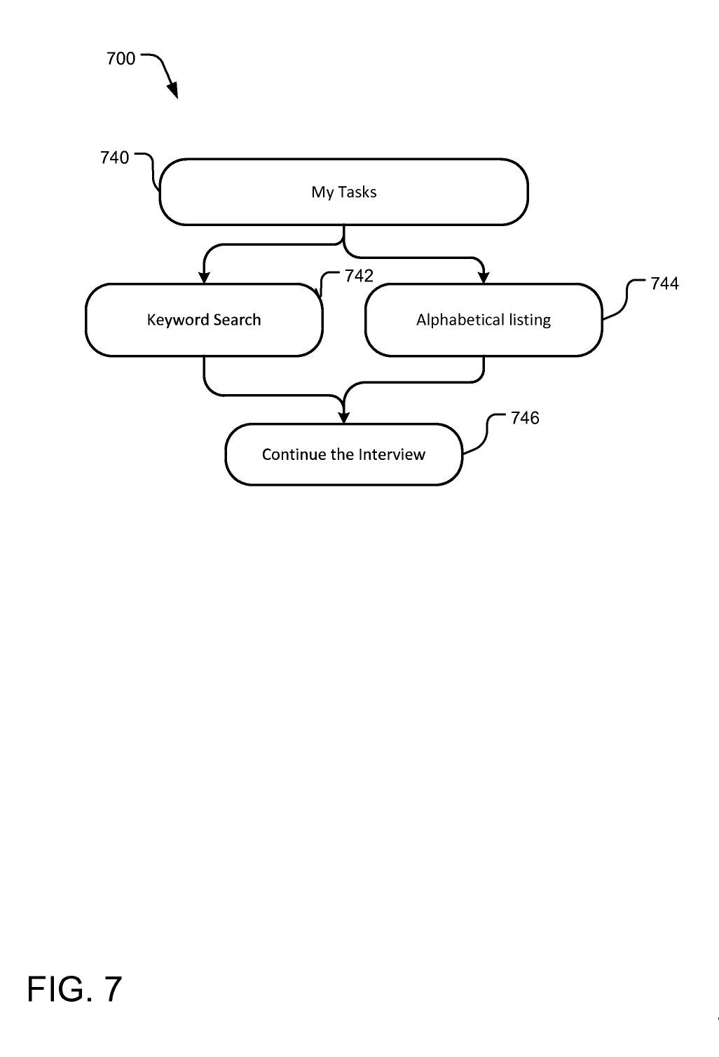

FIG. 7 is an example flow diagram 700 of operations in response to selection of the “my tasks” tab 740 from step five of the client interview. The client selects as many specialized tasks as they need to adequately account for all the other tasks they perform specific to their business, which are not included in the standard tasks tab 548. The client can search for specialized tasks by keyword 742 or browse through an alphabetical listing 744 of over 6,500 tasks. After selecting the specialized tasks needed the client can continue the interview by selecting the continue interview button 746.

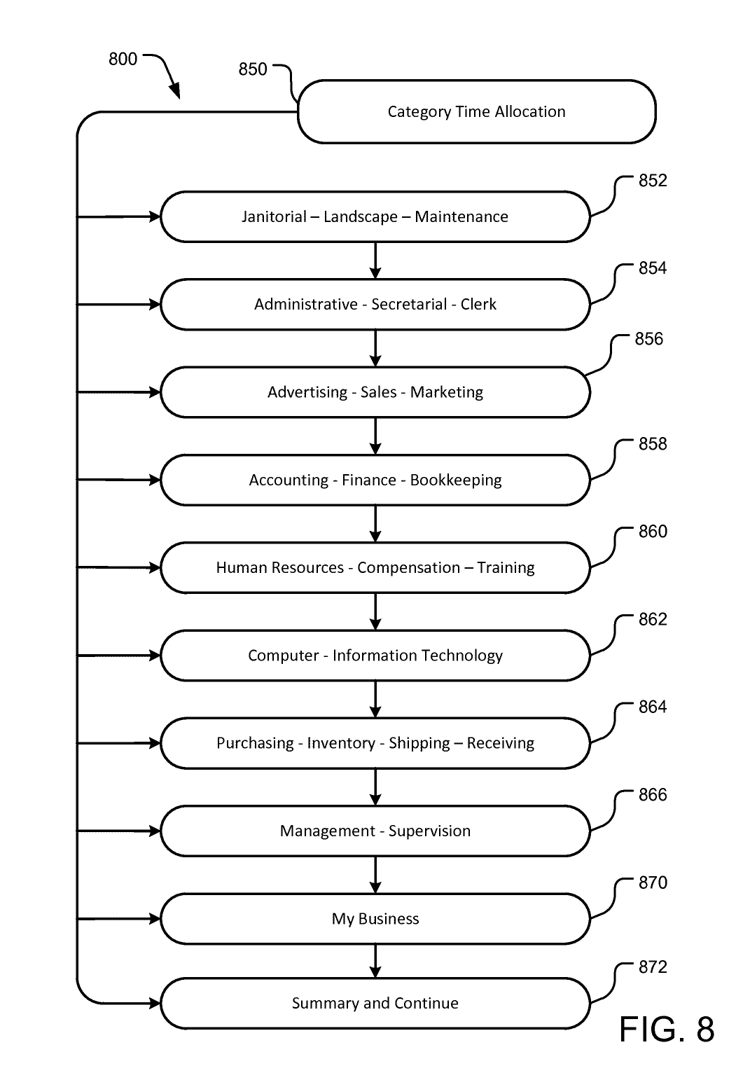

FIG. 8 is an example flow diagram 800 of operations in response to the selection of the “category time allocation” tab 850 from step six of the client interview. In this step the client apportions their time by category from the selections they made in the standard tasks tab 820 and my tasks tab 840. The client must account for all their time in each category 852-870 of FIG. 8 before they can continue to the next step of the client interview. An operation 872 provides a summary and an option to continue.

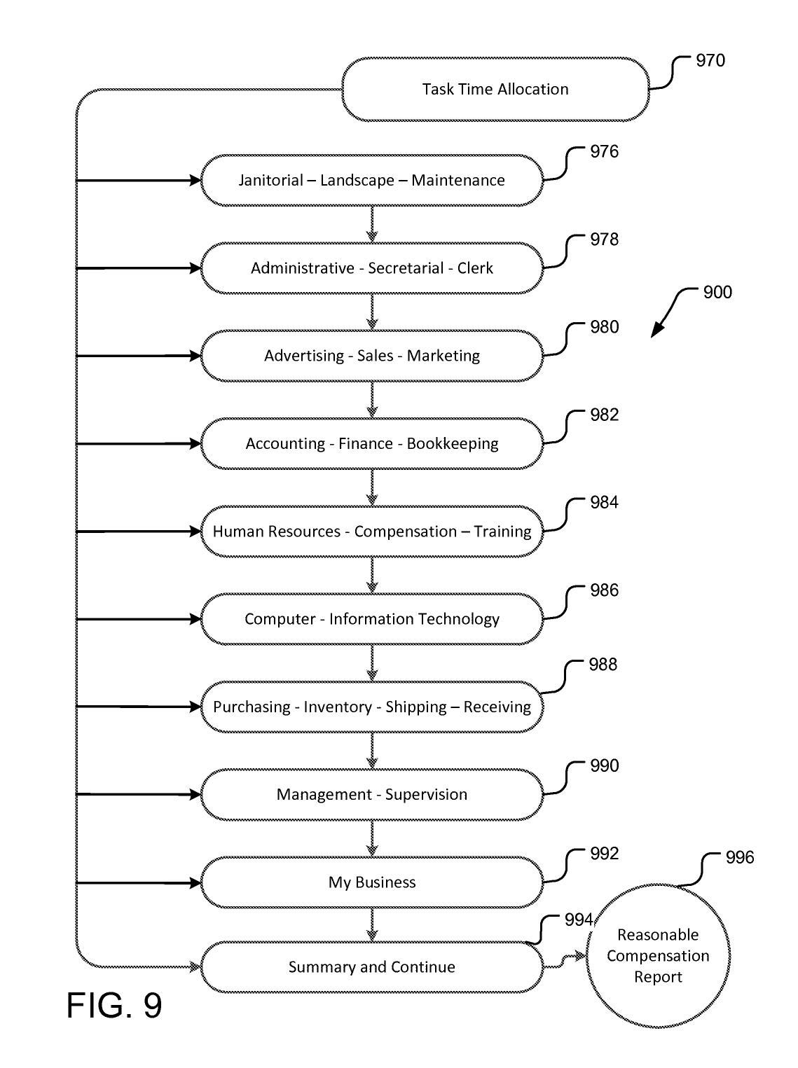

FIG. 9 is an example flow diagram 900 of operations in response to the “task time allocation” tab 970 from step seven of the client interview. In this step the client will go through each of the categories 976-992 where they selected one or more tasks. They will apportion the amount of time they spend on tasks in categories they selected more than one task. The client will also select their proficiency on all tasks selected in step four. After the client has rated their proficiency or skill level in each task and apportion all their time within each category they can proceed to the summary and continue tab 994 to see a summary of all their answers to the interview. The client then clicks the view my report button to generate a reasonable compensation report 996.

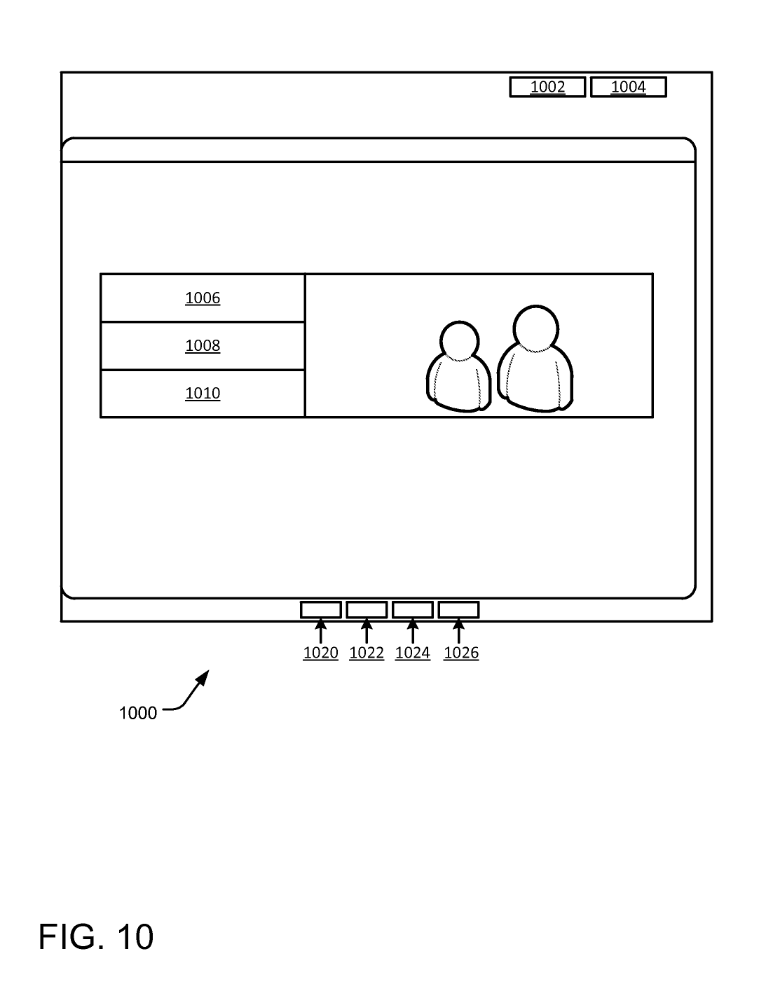

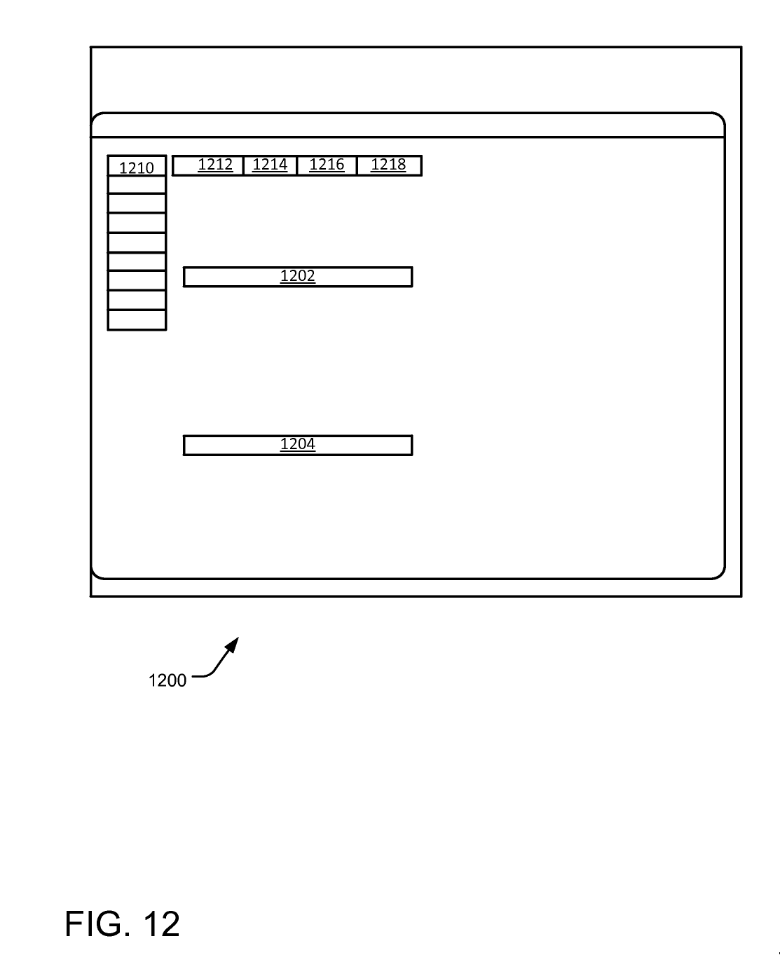

FIG. 10 illustrates an example home page. From the home page the user can log in 1002 to their account using a password 1004 and proceed to their dashboard FIG. 12, select solutions and more information tailored to their profession 1006, 1008, 1010. The four links at the bottom of the home page re-appear at the bottom of all pages of the web site and enable the user to go directly to the home page 1020, link to frequently asked questions (FAQ) 1022, link to the contact us page 1024, and link to the privacy policy 1026.

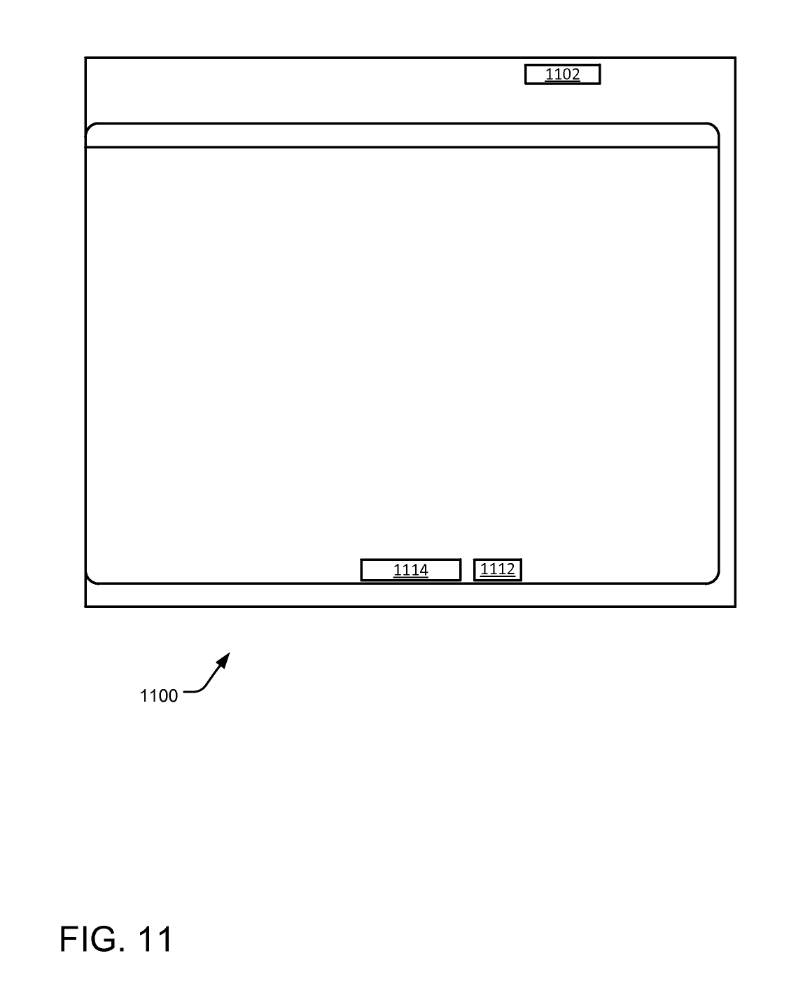

FIG. 11 illustrates an example industry specific landing page. Here the user can login 1102, view a sample reasonable compensation report 1114, view sales and educational videos, and register their firm 1112.

FIG. 12 illustrates an example user interface 1200 for a user dashboard “my clients” tab 1210. From here the user can see client alerts, listing 1202 of clients with reports in progress and listing 1204 of clients with reports in review. Reports in review can be edited by either the user or the client for 30 days following the completion of the reasonable compensation interview and are then locked. A user can also select a home tab 1212, a client profile tab 1214, a client reports tab 1216, or an add new client tab 1218.

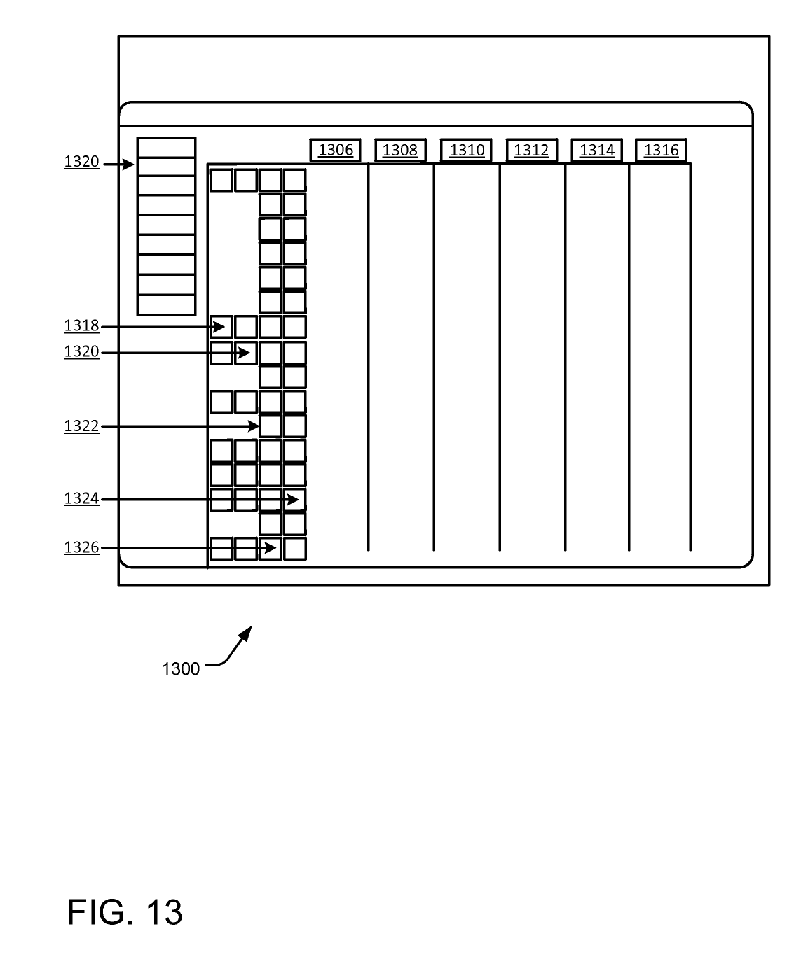

FIG. 13 illustrates an example user interface 1300 for a user dashboard my reports tab 220. From here the user can view a complete history of all reports he ordered for his client's 1306, the date the report was started 1308, the last date the report was edited 1310, the date the interview was completed 1312, the number of days left in the edit period 1314, and the day the report will lock on 1316. The user can also view a completed report for a given client by clicking on the view report icon 1318, print a completed report for a given client by clicking on the print icon 1320, edit a report for a given client by clicking on the edit icon 1322 and send a link to a client to that client's report using the send report icon 1314. Furthermore, the user can also see the reports that have locked and can no longer be edited using the report locked icon 13426, takes the place of the edit icon 1322 when a client's report is locked.

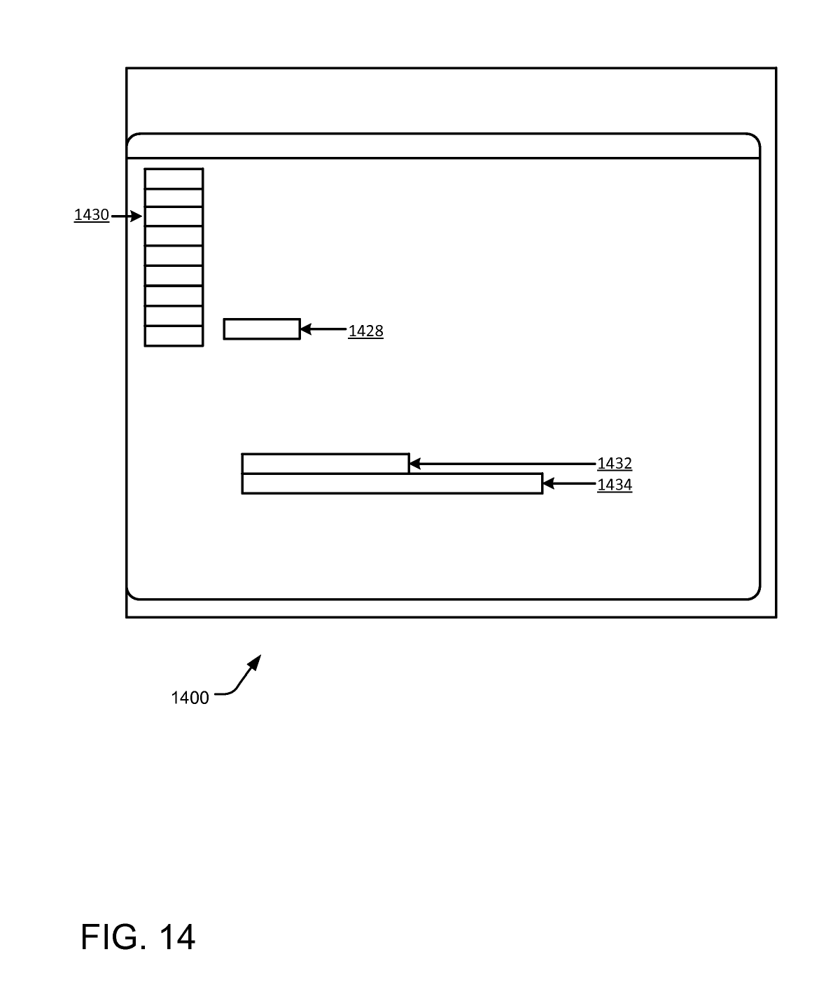

FIG. 14 illustrates an example user interface 1400 for a user dashboard order report tab 1430. From here the user can order or initiate 1428 a report for a client. After ordering the report the user can click on the “begin work on this report” link 1432, and begin the reasonable compensation interview immediately. Alternatively the user can click the “send client an email invitation” link 1434, to initiate an email that contains a link to begin the reasonable compensation interview for the client.

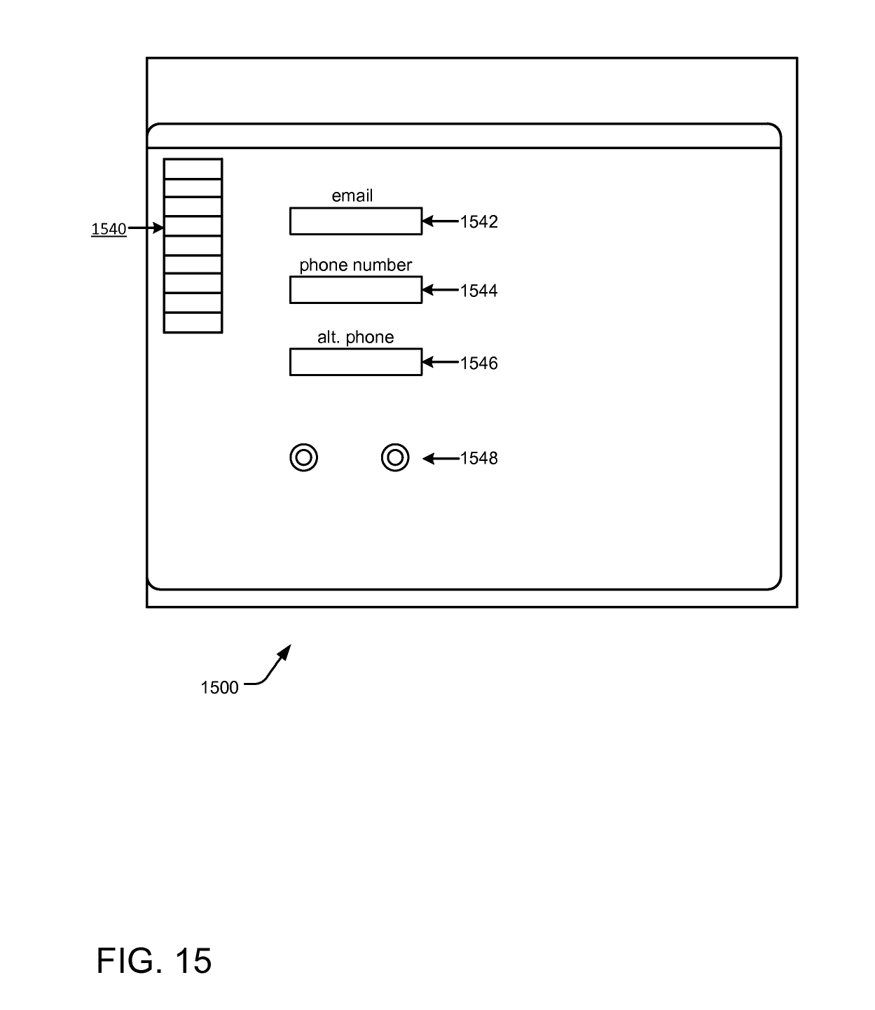

FIG. 15 illustrates an example user interface 1500 for a user dashboard my profile tab 1540. Here the user can edit their profile information such as email address 1542, phone numbers 1544, 1546 and preference 1548 for receiving product updates and newsletters.

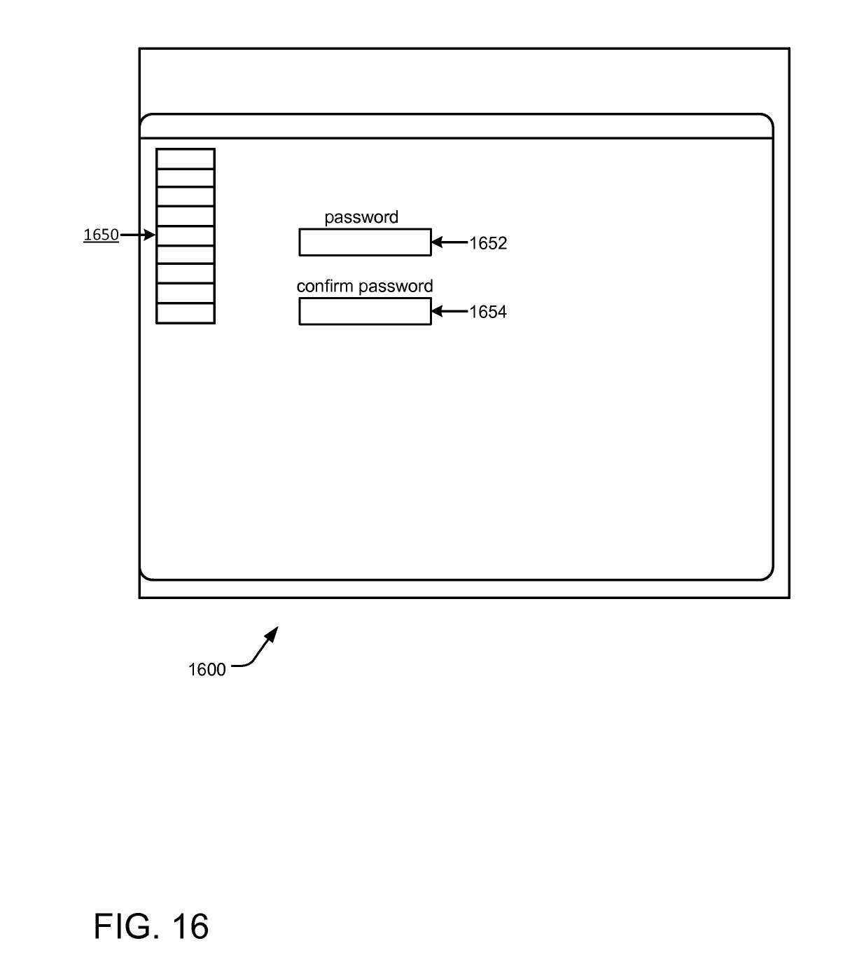

FIG. 16 illustrates an example user interface 1600 for a user dashboard my password tab 1650. Here the user can change their password by providing the password at input field 1652 and confirming the password at input field 1654.

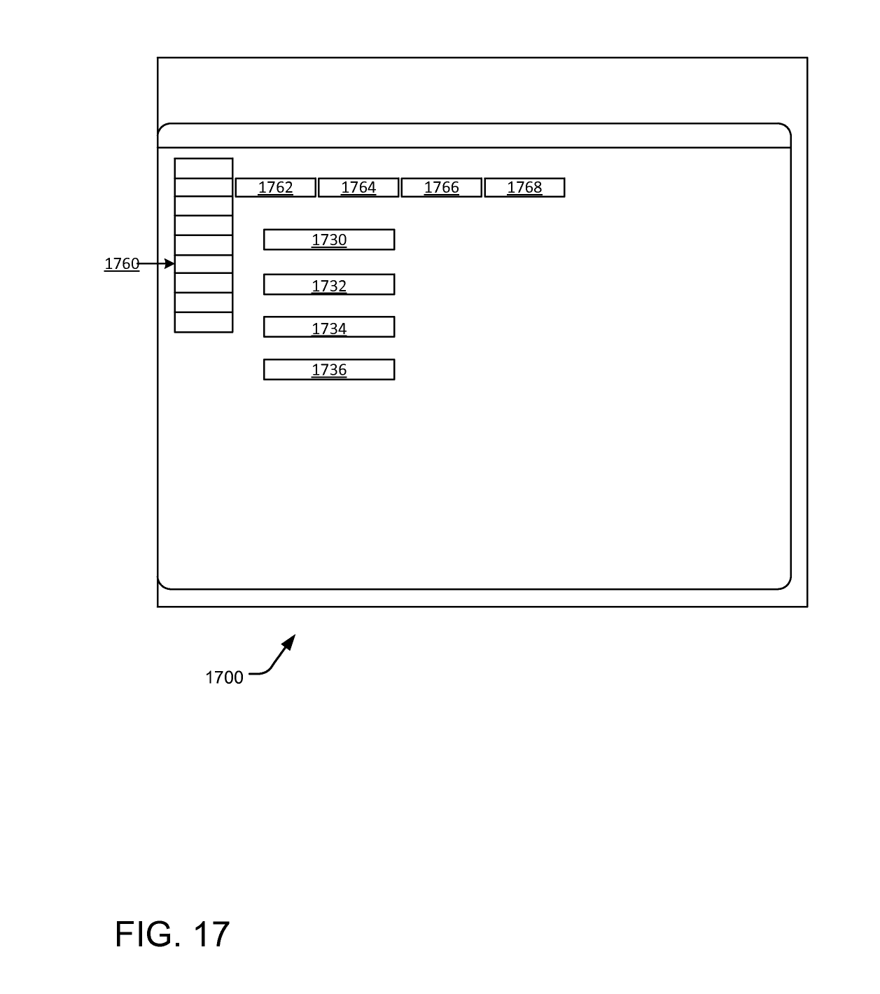

FIG. 17 illustrates an example user interface 1700 for a user dashboard system users tab 1760. The user interface 1700 allows the user to view company and user alerts using system users home page option 1762, select edit other users profiles option 1764, manage other users permissions with option 1766, and add additional users to the firms account with option 1768, and. If a user is also designated as an administrator for the firm, the user can change other user's permissions. The permissions that can be turned on and off are (1) allowing active user to log in to their account or not 1730, (2) allowing an active user to access the firms credit pool to order client reports 1732, (3) allowing the user to purchase credit on the firms behalf 1734, and whether a user can function as an alternate or additional administrator for the firm 1736.

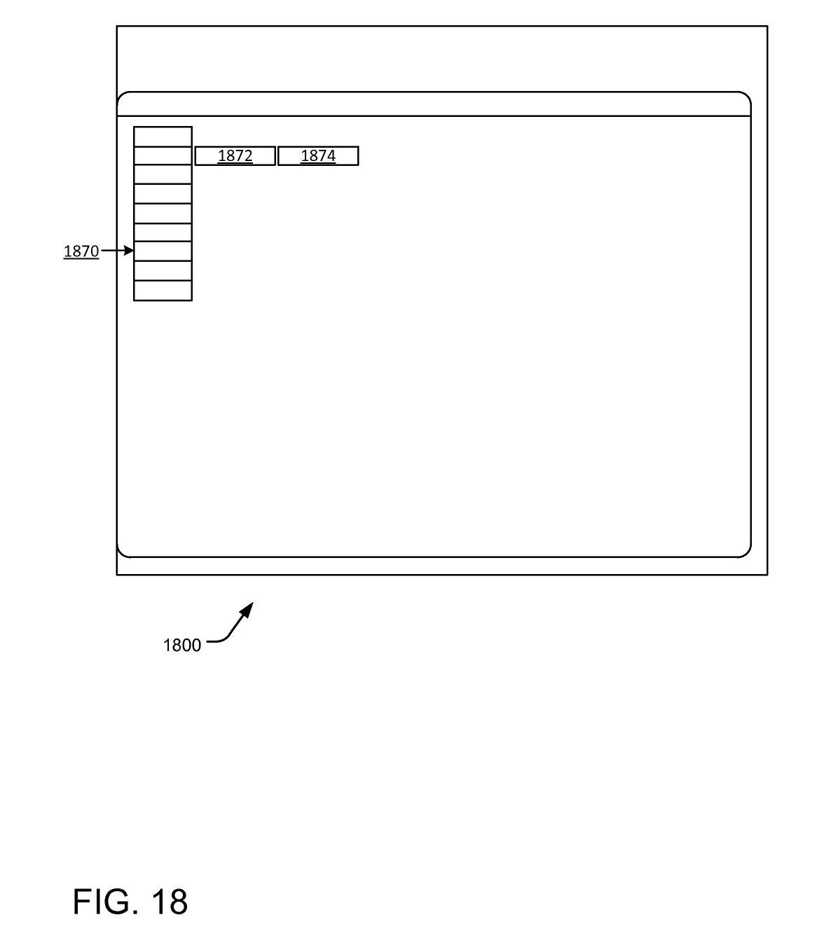

FIG. 18 illustrates an example user interface 1800 for a user dashboard credit pool tab 1870. The user interface 1800 allows the user to purchase credits for their firm using a tab 1872. The credits are a way to buy the Reasonable Compensation reports generated by the system disclosed herein. The Reasonable Compensation reports may be in packages that are suited for different business types and firm size. The user can also view a pricing matrix using a tab 1874 to see the costs for various different reports by report type and credit package.

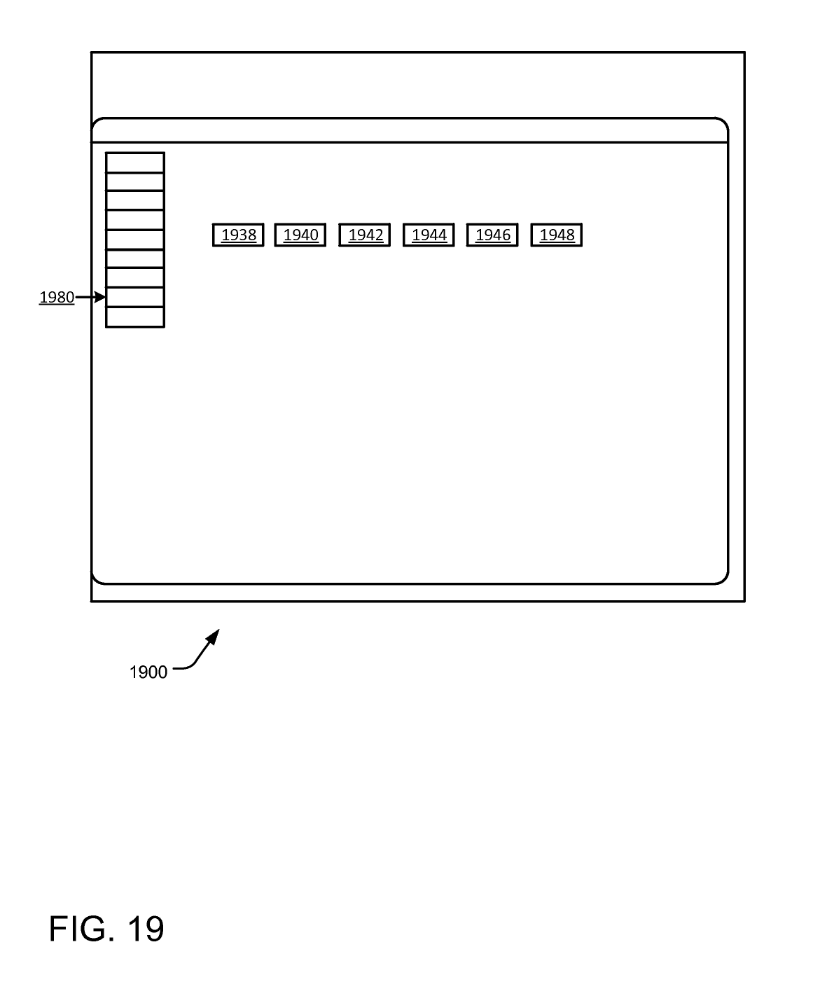

FIG. 19 illustrates an example user interface 1900 for a user dashboard pool history tab 1980. The user interface 1900 allows the user to view a complete history of all credit purchases for the firm and a complete history of all reports ordered using various tabs 1938—1948. For example, the user can review such reports by date the report is generated 1938, by type of report 1940, by user 1942, by client or detail 1944, by credit available per transaction 1946, and by credit balance 1948.

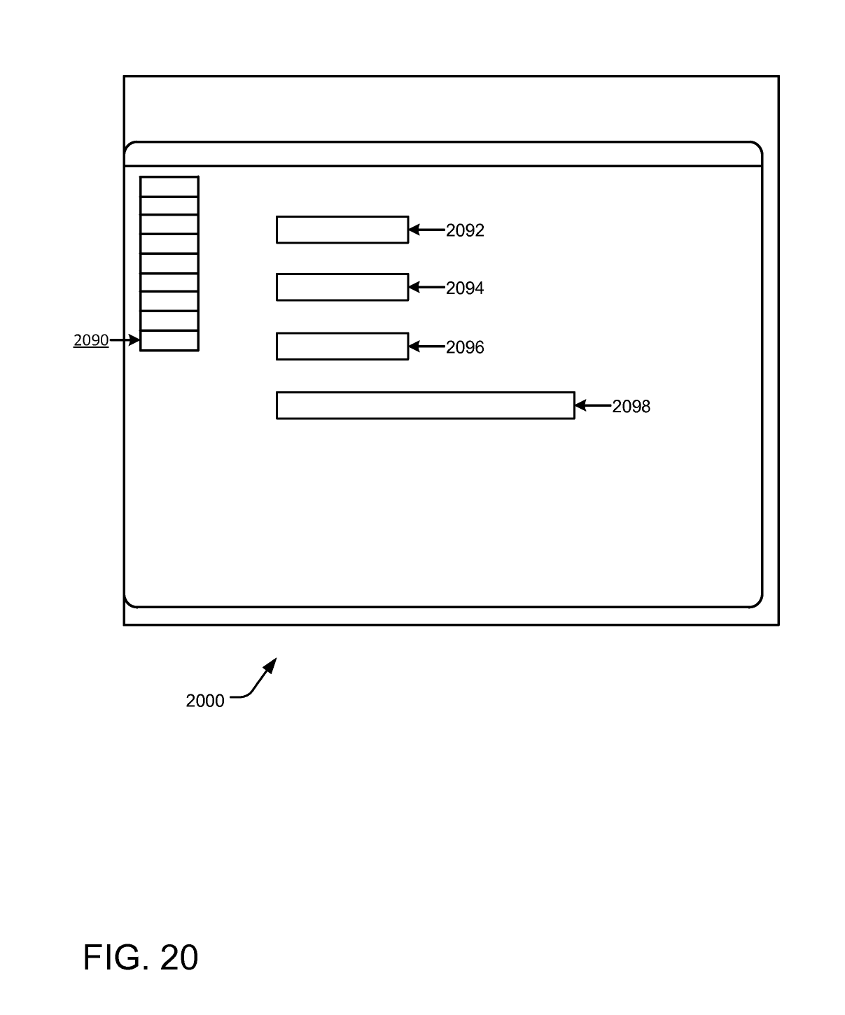

FIG. 20 illustrates an example user interface 2000 for a user dashboard help tab 2090. Here the user can quickly link to help articles using tab 2092, view trainer videos by selecting a tab 2094, view frequently asked questions using a tab 2096, and send an email with questions or comments using a tab 2098.

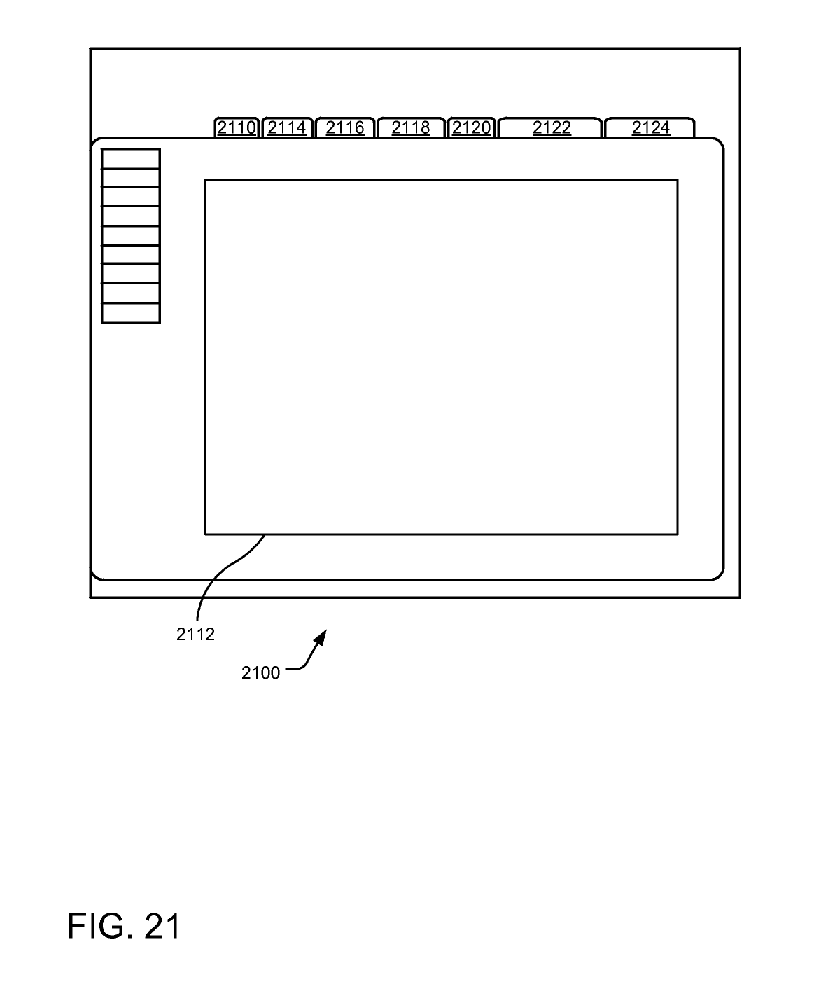

FIG. 21 illustrates an example client interface 2100 for a client interview my state tab 2110. This is step one of the client interview. Here the client selects which state they perform work in. For example a user can select a client interview by state tab 2110 to receive a listing of states 2112 and the user can select a state from the listing 2112 to initiate the interview. Additional tabs 2114-2124 allow a user to initiate such an interview by county, by company, by standard tasks, by personal tasks, by category time allocation, and by task time allocation.

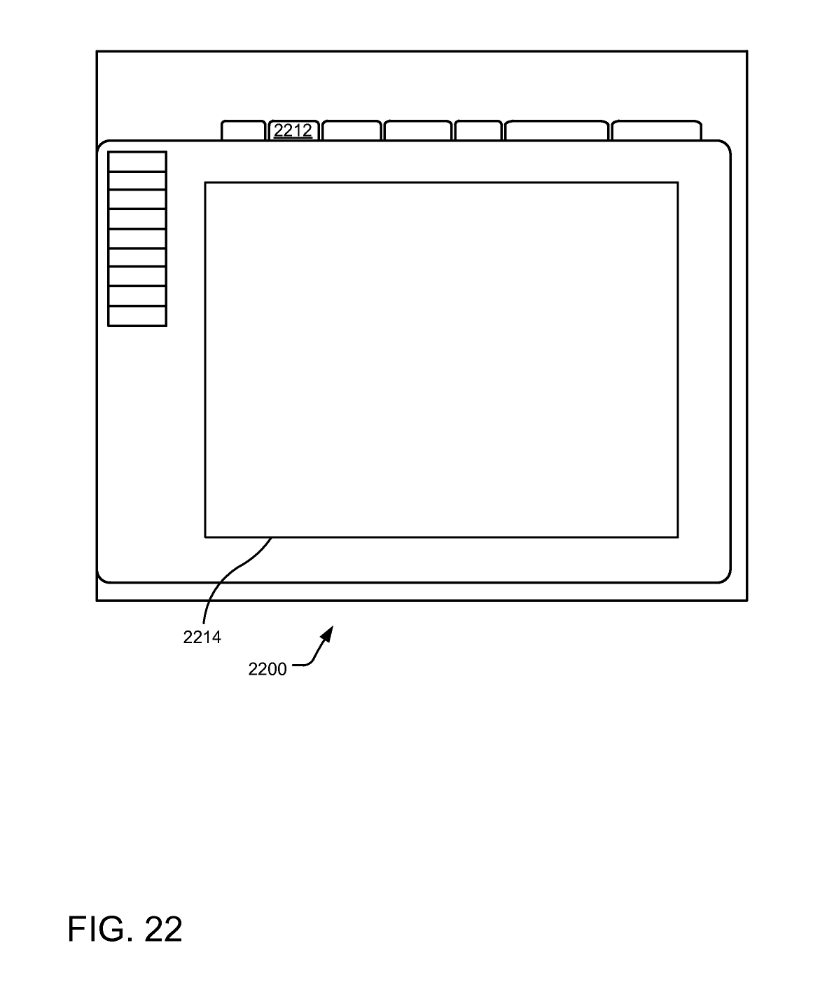

FIG. 22 illustrates an example client interface 2200 to initiate client interviews. The client interface 2200 may be presented to the user in response to selection of my county tab 2212. The user interface 2200 provides a listing of counties 2214 and the user can select one or more of the counties where the user performs various tasks.

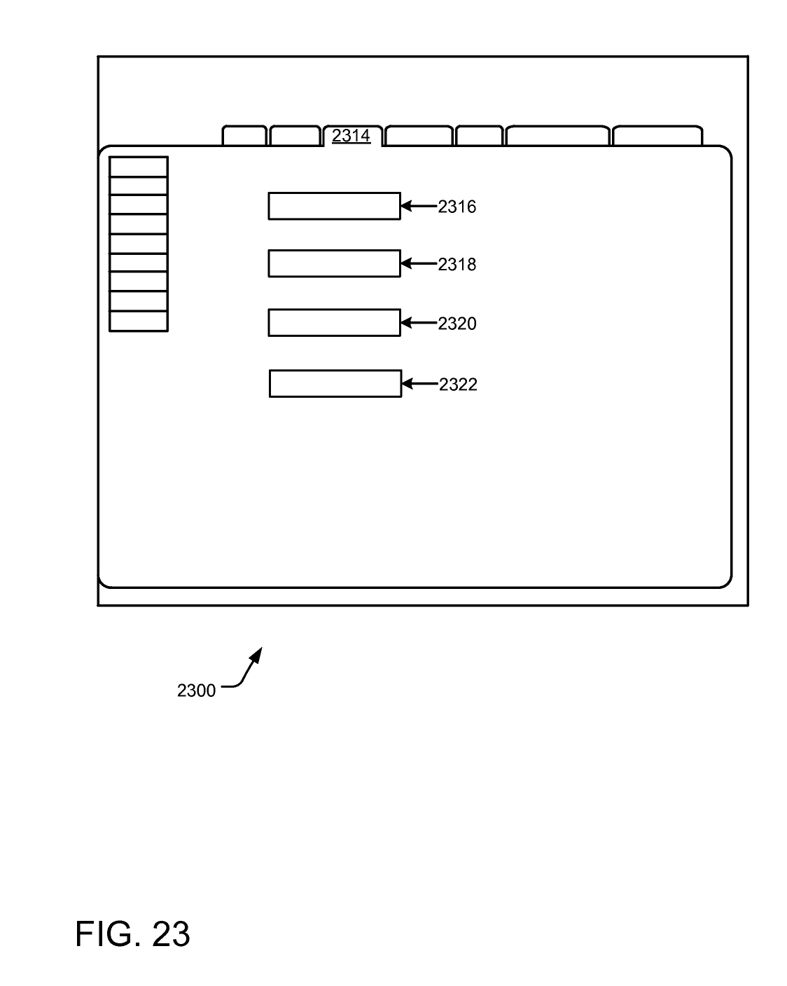

FIG. 23 illustrates an example client interface 2300 when the user selects the client interview my company tab 2314. This is the third step of the client interview. Here the client provides information about his company such as number of employees 2316, annual revenue for the company 2318, number of shareholders for the company 2320, and the number of hours they typically perform work for their company each week 2322.

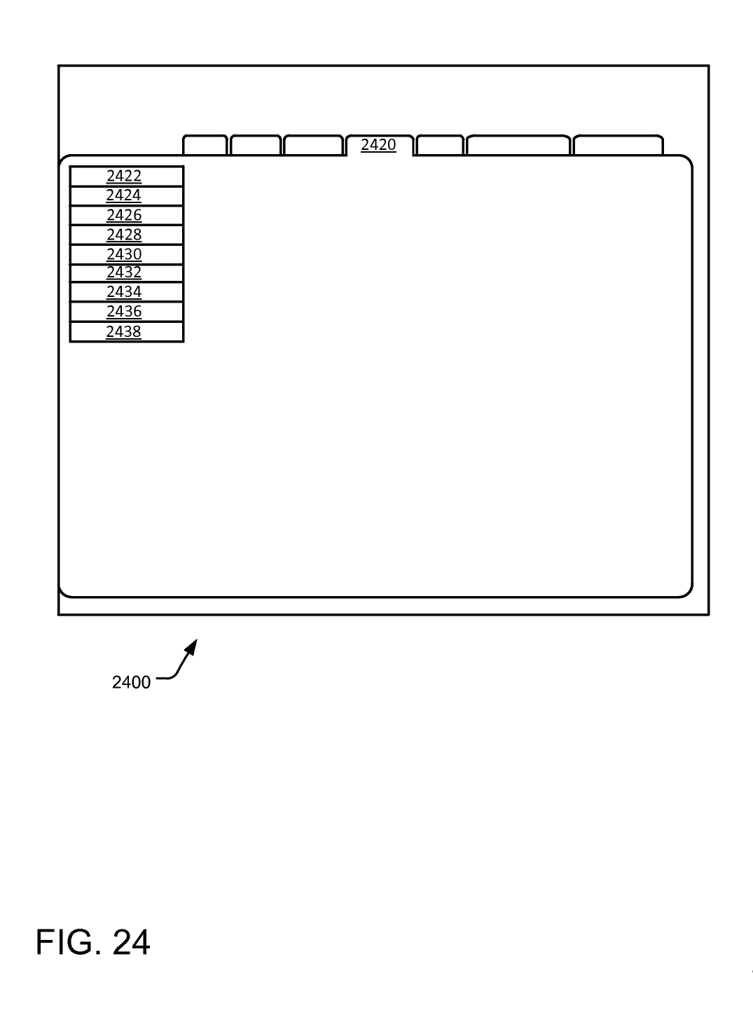

FIG. 24 illustrates an example client interface 2400 when the user selects the client interview standard tasks tab 2420. This is the fourth step of the client interview. Here the client proceeds through eight standard categories 2422-2438 most small business owners perform job duties or tasks in. The client selects any tasks they typically perform in work in over the course of the year. For example, if the client selects the management category 2436, the user interface 2400 presents questions such whether the user performs general and operational management tasks, sales management, advertising management, etc. In an alternative implementation, the client interface 2400 may also ask the user about the number of hours that the user works on each of these management tasks.

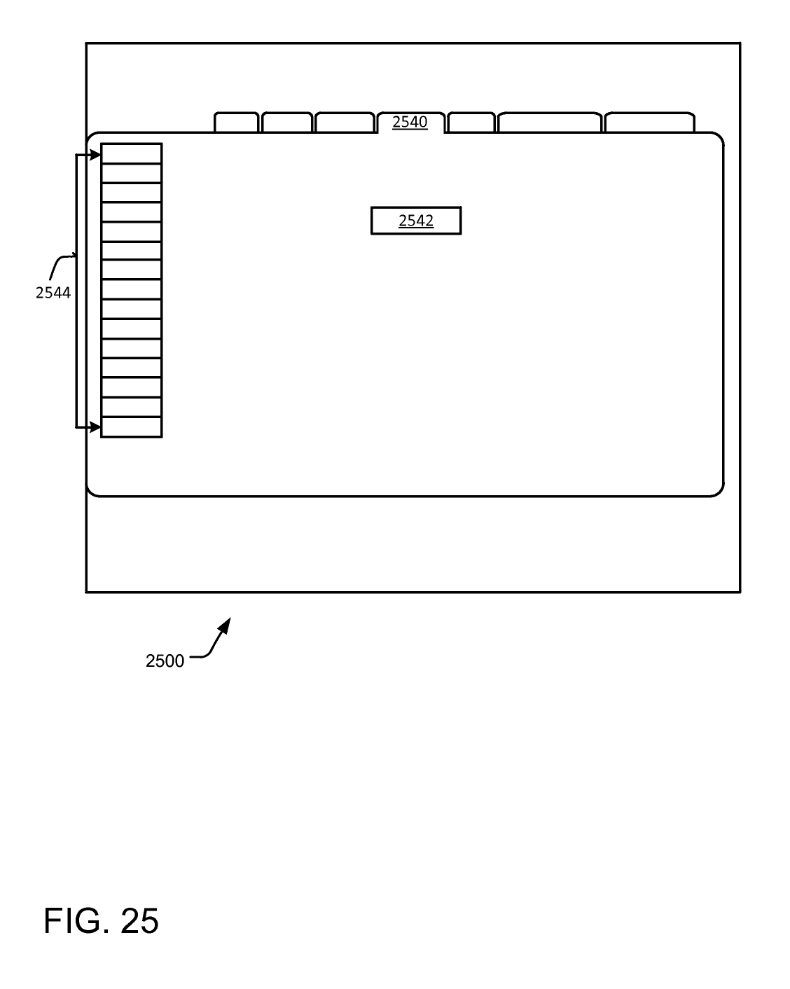

FIG. 25 illustrates an example client interface 2500 when a user selects the client interview my tasks tab 2540. This is the fifth step of the client interview. Here the client selects as many other tasks not included in step four needed to adequately account for any and all other tasks they typically perform in a year. In the illustrated implementation, the user can search for tasks by key word using the option 2542 and/or using the alphabetical listing 2544.

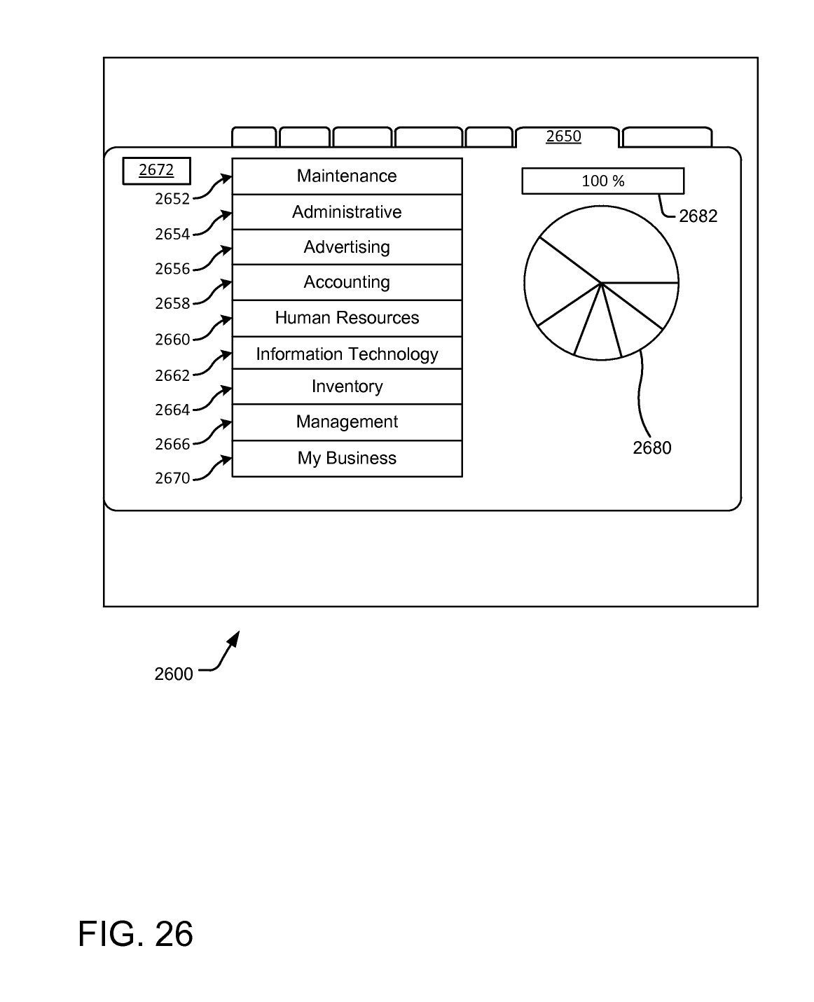

FIG. 26 illustrates an example client interface 2600 when a client selects the client interview category time allocation tab 2650. This is the sixth step of the client interview. In this step the client apportions for their time by category from the standard categories 2652-2666 and the custom category 2670 of step five. The user can select the time for each of the categories 2652-2666 using a sliding tab or by some other input GUI. The client interface 2600 also provides the user with graphical representation 2680 of the amount of time spent in each of the categories 2652-2670 and numerical representation 2682 of total time allocated.

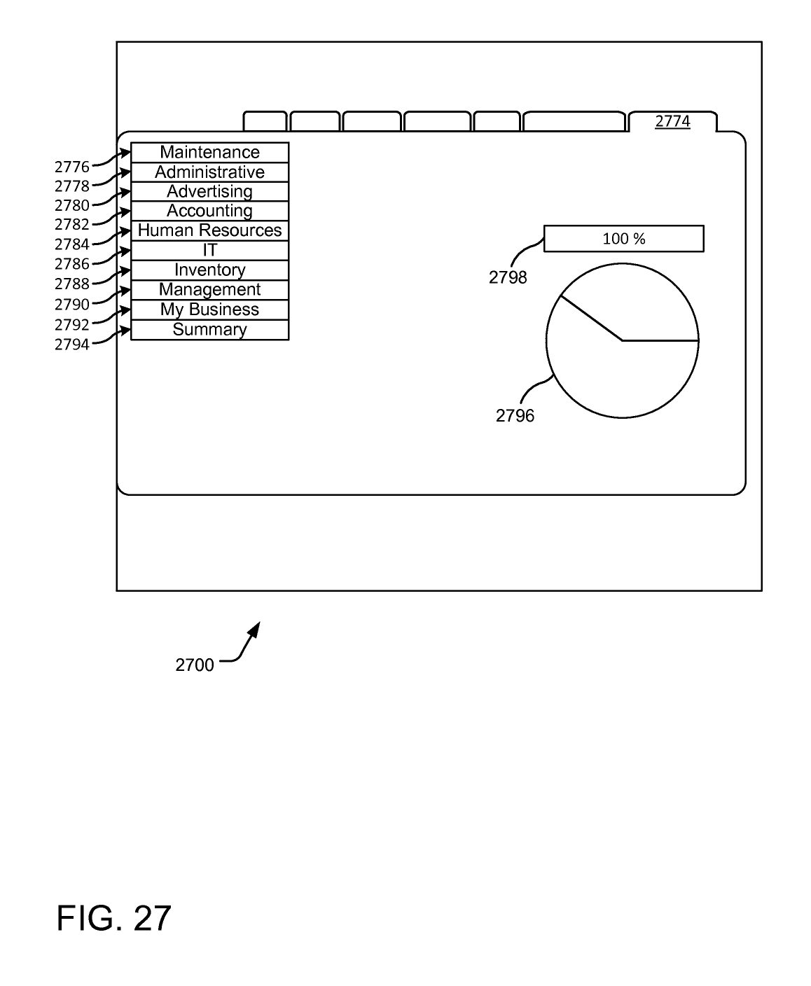

FIG. 27 illustrates an example client interface 2700 when the user selects the client interview task time allocation tab 2774. This is the seventh step of the client interview. In this step the client apportions their time within each category 2776-2794. The client also selects their proficiency or skill level for each task selected in step four and five. The client interface 2700 also provides the user with graphical representation 2796 of the amount of time spent in each of the categories 2776-2794 and numerical representation 2798 of total time allocated.

FIG. 2800 illustrates an example reasonable compensation report 2800 that the user can view by selecting a tab 2806. A single value 2810 is calculated as the client's reasonable compensation figure based on their input in steps one through seven of the reasonable compensation interview. The compensation report 2800 also provides amount of time in percentages 2822 and in number of hours 2824 for each of the various tasks 2812, 2814, etc. Furthermore, the compensation amount 2826 allocated to each of these tasks 2812, 2814 is also provided.

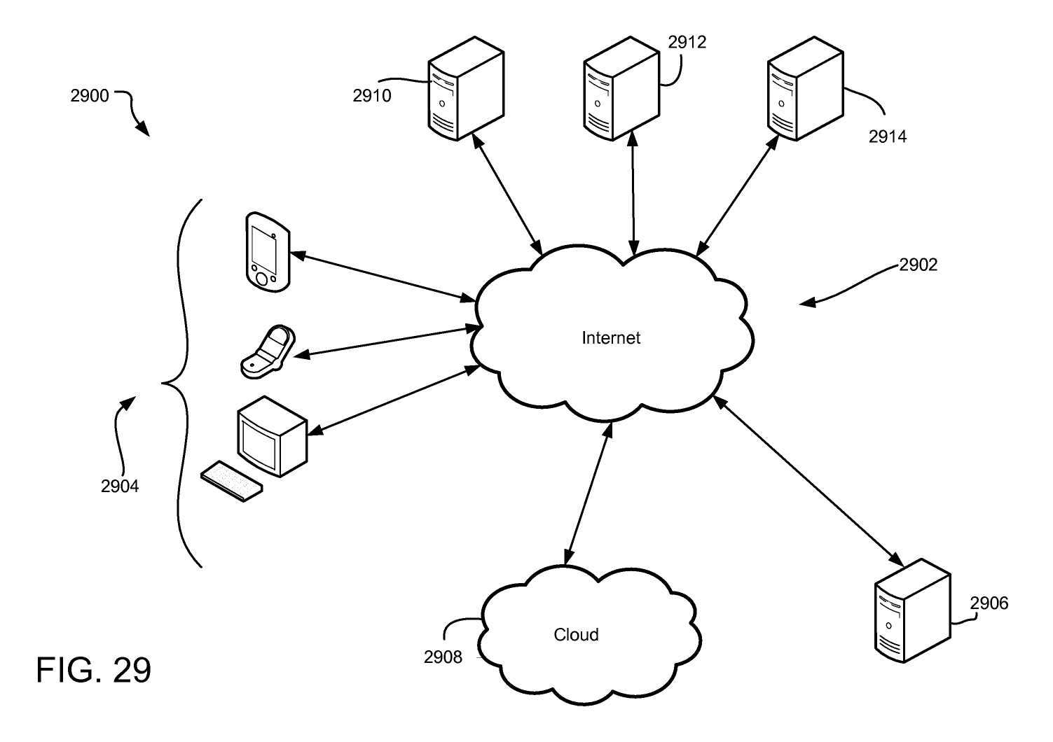

FIG. 29 illustrates an example network environment 2900 for implementing the compensation recommendation system described herein. Specifically, FIG. 29 illustrates a communications network 2902 (e.g., the Internet) that is used by one or more computing or data storage devices for implementing the system for information cataloging. In one implementation, one or more user devices 2904 are communicatively connected to the communications network 2902. Examples of the user devices 2904 include a personal computer, a laptop, a smart-phone, tablet or slate (e.g., iPad), etc. A user interested in the compensation system uses such user devices 2904 to access the compensation system that may reside on one or more of the servers 2904, 2910, 2912, 2914, etc. Furthermore, one of more of the modules of the compensation system may also be stored on a cloud 2908.

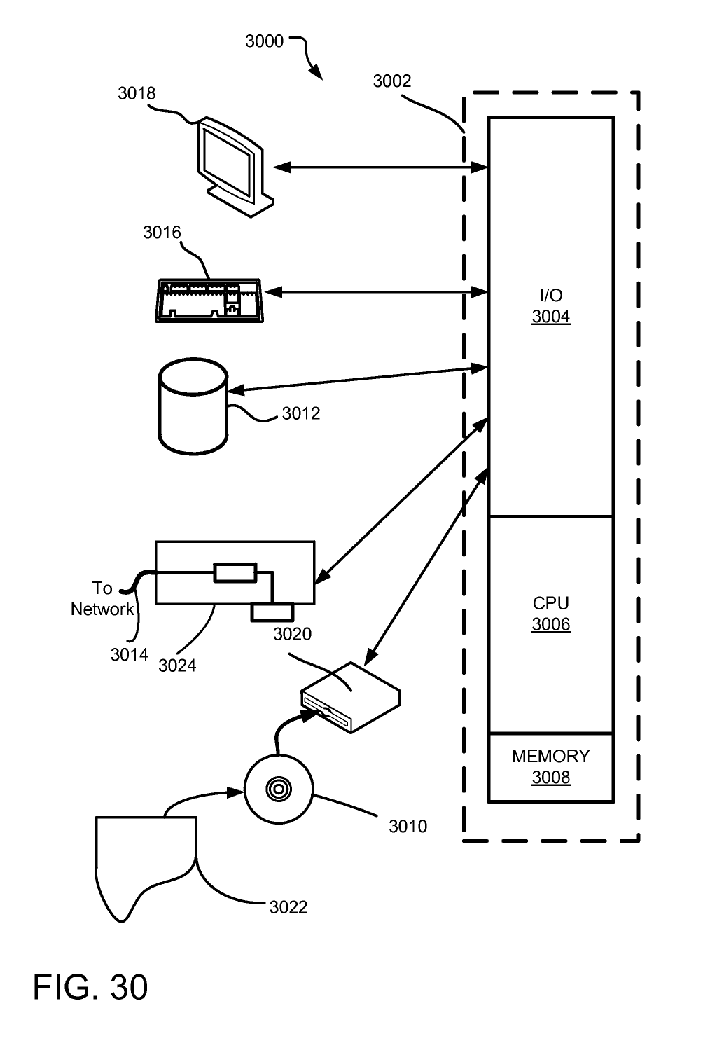

FIG. 30 illustrates an example computing system that can be used to implement one or more components of the compensation recommendation method and system described herein. A general-purpose computer system 3000 is capable of executing a computer program product to execute a computer process. Data and program files may be input to the computer system 3000, which reads the files and executes the programs therein. Some of the elements of a general-purpose computer system 3000 are shown in FIG. 30, wherein a processor 3002 is shown having an input/output (I/O) section 3004, a Central Processing Unit (CPU) 3006, and a memory section 3008. There may be one or more processors 3002, such that the processor 3002 of the computer system 3000 comprises a single central-processing unit 3006, or a plurality of processing units, commonly referred to as a parallel processing environment. The computer system 3000 may be a conventional computer, a distributed computer, or any other type of computer such as one or more external computers made available via a cloud computing architecture. The described technology is optionally implemented in software devices loaded in memory 3008, stored on a configured DVD/CD-ROM 3010 or storage unit 3012, and/or communicated via a wired or wireless network link 3014 on a carrier signal, thereby transforming the computer system 3000 in FIG. 30 to a special purpose machine for implementing the described operations.

The I/O section 3004 is connected to one or more user-interface devices (e.g., a keyboard 3016 and a display unit 3018), a disk storage unit 3012, and a disk drive unit 3020. Generally, in contemporary systems, the disk drive unit 3020 is a DVD/CD-ROM drive unit capable of reading the DVD/CD-ROM medium 3010, which typically contains programs and data 3022. Computer program products containing mechanisms to effectuate the systems and methods in accordance with the described technology may reside in the memory section 3004, on a disk storage unit 3012, or on the DVD/CD-ROM medium 3010 of such a system 3000, or external storage devices made available via a cloud computing architecture with such computer program products including one or more database management products, web server products, application server products and/or other additional software components. Alternatively, a disk drive unit 3020 may be replaced or supplemented by a floppy drive unit, a tape drive unit, or other storage medium drive unit. The network adapter 3024 is capable of connecting the computer system to a network via the network link 3014, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 3000 is connected (by wired connection or wirelessly) to a local network through the network interface or adapter 3024, which is one type of communications device. When used in a WAN-networking environment, the computer system 3000 typically includes a modem, a network adapter, or any other type of communications device for establishing communications over the wide area network. In a networked environment, program modules depicted relative to the computer system 3000 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 3008 or other storage systems, such as disk storage unit 3012 or DVD/CD-ROM medium 3010 and/or other external storage device made available and accessed via a cloud computing architecture. Still further, some or all of the operations for the system for recommendation disclosed herein may be performed by the processor 3002. In addition, one or more functionalities of the system disclosed herein may be generated by the processor 3002 and a user may interact with these GUIs using one or more user-interface devices (e.g., a keyboard 3016 and a display unit 3018) with some of the data in use directly coming from third party websites and other online sources and data stores via methods including but not limited to web services calls and interfaces without explicit user input.

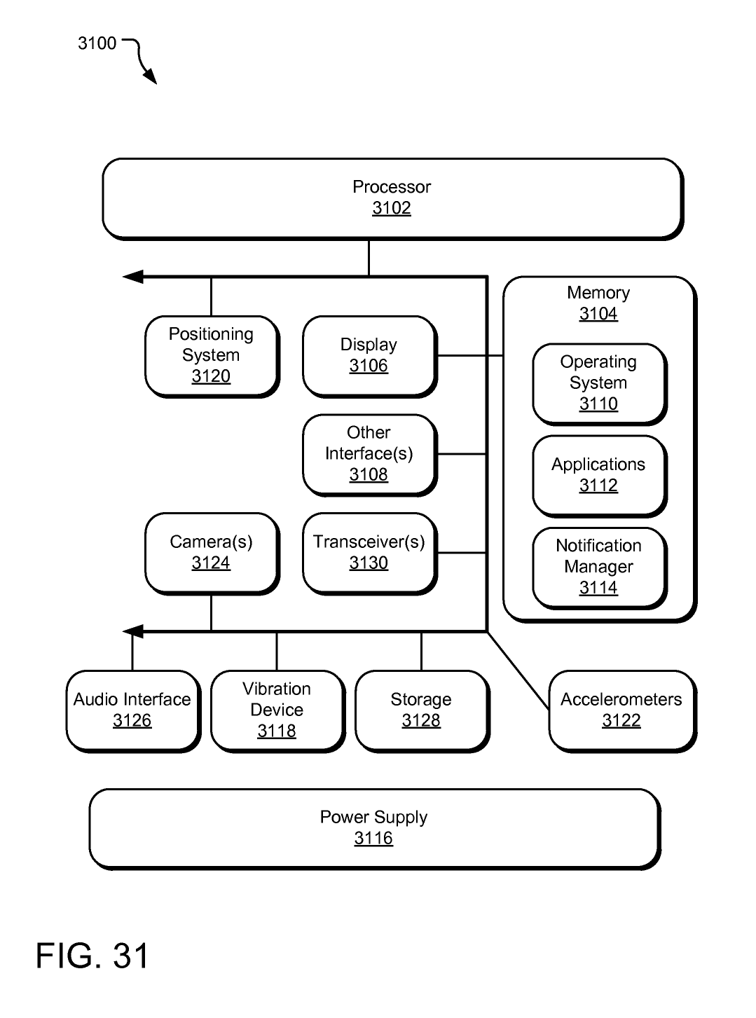

FIG. 31 illustrates an example mobile computing device 3100 that can be used to implement one or more components of the recommendation system disclosed herein. Specifically, the mobile computing device 3100. The mobile device 3100 includes a processor 3102, a memory 3104, a display 3106 (e.g., a touchscreen display), and other interfaces 3108 (e.g., a keyboard). The memory 3104 generally includes both volatile memory (e.g., RAM) and non-volatile memory (e.g., flash memory). An operating system 3110, such as the Microsoft Windows® Phone 7 operating system, resides in the memory 3104 and is executed by the processor 3102, although it should be understood that other operating systems may be employed.

One or more application programs 3129 are loaded in the memory 3104 and executed on the operating system 3110 by the processor 3102. Examples of applications 3129 include without limitation email programs, scheduling programs, personal information managers, Internet browsing programs, multimedia player applications, etc. In one implementation, a recommendation application stored in the memory 3104 may be used to catalog various observations stored on the mobile device 3100, such as e-mail addresses from the e-mail application of the mobile device, the contacts from a contact management application stored on the mobile device 3100, etc. In yet alternate implementation, a client application stored in the memory 3104 of the mobile device 3100 may generate queries using the information stored on the mobile device 3100, receive entity relation information from a server generating relations between various elements, and display updated observations to a user of the mobile device 3100. A notification manager 3114 is also loaded in the memory 3104 and is executed by the processor 3102 to present notifications to the user. For example, when a promotion is triggered and presented to the shopper, the notification manager 3114 can cause the mobile device 3100 to beep or vibrate (via the vibration device 3118) and display the promotion on the display 3106.

The mobile device 3100 includes a power supply 3116, which is powered by one or more batteries or other power sources and which provides power to other components of the mobile device 3100. The power supply 3116 may also be connected to an external power source that overrides or recharges the built-in batteries or other power sources.

The mobile device 3100 includes one or more communication transceivers 3130 to provide network connectivity (e.g., mobile phone network, Wi-Fi®, BlueTooth®, etc.). The mobile device 3100 also includes various other components, such as a positioning system 3120 (e.g., a global positioning satellite transceiver), one or more accelerometers 3122, one or more cameras 3124, an audio interface 3126 (e.g., a microphone, an audio amplifier and speaker and/or audio jack), and additional storage 3128. Other configurations may also be employed.

Embodiments of the present technology are disclosed herein in the context of a recommendation system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method of, comprising:
determining compensations for a plurality of tasks;
determining time spent by a user on the one or more of the plurality of tasks; and
determining the reasonable compensation of the user using the compensations for the one or more of the plurality of tasks and the time spent by the user on the one or more of the plurality of tasks.

2. The method of claim 1, wherein determining time spent by a user on the one or more of the plurality of tasks further comprises presenting an online questionnaire to the user to receive the time.

3. The method of claim 2, wherein presenting the questionnaire further comprises:
receiving time spent by the user in one or more of standard task categories; and
receiving time spent by the user in one or more of personal task categories.

4. The method of claim 3, wherein the standard task categories include at least one of (1) janitorial tasks, (2) administrative tasks, (3) advertising tasks, (4) accounting tasks, (5) human resource tasks, (6) information technology tasks, (7) purchasing tasks, and (8) management tasks.

5. The method of claim 3, wherein the personal tasks categories are selected based on at least one of (1) keyword search and (2) based on a listing of the personal task categories.

6. The method of claim 1, wherein determining the compensations for the plurality of tasks further comprises determining the compensations based on a bureau of labor statistics (BLS) database.

7. The method of claim 7, further comprising:
receiving a geographic location of the user, and
adjusting the compensations based on the BLS database using the geographic location of the user.

8. The method of claim 7, further comprising:
receiving an indicator of current economic conditions; and
adjusting the compensations based on the BLS database using an indicator of current economic conditions.

9. The method of claim 1, wherein determining the time spent by the user on the one or more of the plurality of tasks further comprises determining the time spent by the user on the one or more of the plurality of tasks in real-time.

10. The method of claim 1, wherein determining the time spent by the user on the one or more of the plurality of tasks further comprises determining the approximate time spent by the user on the one or more of the plurality of tasks.

11. The method of claim 1, wherein determining compensations for a plurality of tasks further comprising determining a compensation for one of the plurality of tasks based on statistical extrapolation of compensations for another of the plurality of tasks.

12. The method of claim 1, wherein determining compensations for a plurality of tasks further comprising determining a compensation for the one of the plurality of tasks based on statistical extrapolation of compensations for another of the plurality of tasks in a geographical area other than a geographical area of the user.

13. A system, comprising:
a data collection module configured to collect compensation data for a plurality of tasks;
a questionnaire module configured to determine time spent by a user on the one or more of the plurality of tasks; and
a calculation module configured to determine reasonable compensation of the user as compensations for the one or more of the plurality of tasks performed by the user weighted by the time spent by the user on the one or more of the plurality of tasks as a percentage of total time spent by the user on the one or more of the plurality of tasks.

14. The system of claim 13, wherein the data collection module is further configured to collect compensation data from bureau of labor statistics (BLS) database.

15. The system of claim 13, wherein the data collection module is further configured to generate compensation data for one or more of the plurality of tasks based on comparison of the one or more of the plurality of tasks with other one or more of the plurality of tasks.

16. The system of claim 16, wherein the questionnaire module presents one or more of the plurality of tasks to the user based on a size of business of the user.

17. The system of claim 16, further comprising a real-time time collection module configured to update the time spent by the user on the one or more of the plurality of tasks based on actual time spent by the user on the one or more of the plurality of tasks.

18. One or more computer-readable storage media encoding computer-executable instructions for executing on a computer system a computer process, the computer process comprising:
determining reasonable compensations for a plurality of tasks;
determining a predetermined number of standard task categories;
allocating each of the plurality of tasks to one of a plurality of standard task categories;
determining reasonable compensation for each of the plurality of standard task categories;
determining time spent by the user on one or more of the standard task categories;
determining reasonable total compensation of the user using the reasonable compensations for the one or more of the plurality of v and the time spent by the user on the one or more of the plurality of standard task categories.

19. The one or more computer-readable storage media of claim 18, wherein the computer process for determining the reasonable compensation further comprising:
determining time spent by the user on a personal task not allocated to one or more of the standard task categories;
determining reasonable compensation for the personal task; and
updating the reasonable compensation of the user using the time spent by the user on the personal task and the reasonable compensation for the personal task.

20. The one or more computer-readable storage media of claim 19, wherein the computer process for determining the reasonable compensation further comprising:
determining relative amounts of time spent by the user one or more of the plurality of task categories relative to total time spent by the user on all tasks; and
weighting the reasonable compensation for the one or more of the plurality of task categories with the relative amounts of time spent by the user on the one or more of the plurality of task categories to determine the reasonable total compensation for the user.

21. The one or more computer-readable storage media of claim 19, wherein the computer process for determining the reasonable compensation further comprising:
updating the reasonable compensations for the plurality of tasks based on reasonable total compensations of other users.
